(19) United States
(12) Patent Application Publication
(10) Pub. No.: US 2012/0163460 A1
(43) Pub. Date: Jun. 28, 2012

(54) SUB-PIXEL INTERPOLATION FOR VIDEO CODING

(75) Inventors: Wei-Jung Chien, San Diego, CA (US); Marta Karczewicz, San Diego, CA (US)

(73) Assignee: QUALCOMM INCORPORATED, San Diego, CA (US)

(21) Appl. No.: 13/283,196

(22) Filed: Oct. 27, 2011

Related U.S. Application Data
(60) Provisional application No. 61/426,718, filed on Dec. 23, 2010.

(51) Int. Cl. H04N 7/32

(52) U.S. Cl. 375/240.16; 375/E07.113

(57) ABSTRACT

In one example, an apparatus includes a video coder configured to determine a first set of support pixels used to interpolate a value for a first sub-integer pixel position of a pixel of a reference block of video data; determine a second, different set of support pixels used to interpolate a value for a second sub-integer pixel position of the pixel; determine a third, different set of support pixels used to interpolate a value for a third sub-integer pixel position of the pixel; combine corresponding values from the first, second, and third sets of support pixels; apply an interpolation filter to the combined values to calculate a value for a fourth sub-integer-pixel comprising a one-eighth-integer position of the pixel and code a portion of a current block of the video data relative to the fourth one-eighth-integer pixel position of the reference block.

This application claims the benefit of U.S. Provisional Application No. 61/426,718, filed Dec. 23, 2010, which is hereby incorporated by reference in its entirety.

### TECHNICAL FIELD

This disclosure relates to video coding techniques used to compress video data and, more particularly, video coding techniques consistent with the emerging high efficiency video coding (HEVC) standard.

### BACKGROUND

Digital video capabilities can be incorporated into a wide range of video devices, including digital televisions, digital direct broadcast systems, wireless communication devices such as wireless telephone handsets, wireless broadcast systems, personal digital assistants (PDAs), laptop or desktop computers, tablet computers, digital cameras, digital recording devices, video gaming devices, video game consoles, personal multimedia players, and the like. Digital video devices implement video compression techniques as the High Efficiency Video Coding (HEVC) standard being developed by the “Joint Collaborative Team—Video Coding” (JCTVC), which is a collaboration between MPEG and ITU-T, are being developed. The emerging HEVC standard is sometimes referred to as H.265.

### SUMMARY

In general, this disclosure describes video coding techniques, more particularly inter-predictive coding techniques for supporting the use of motion vectors having sub-pixel precision, such as eighth-pixel (⅛^{th} of a pixel) precision. The term “eighth-pixel” in this disclosure is intended to refer to one-eighth fractional pixel positions (⅛^{th}, 2/8^{th}, ⅜^{th}, 4/8^{th}, ⅝^{th}, 6/8^{th}, or ⅞^{th} of a pixel). A video coding device implementing these techniques may execute one interpolation filter to interpolate values for more than one interpolation filter to calculate values for multiple sub-pixel positions, the techniques of this disclosure may allow for increased video coding efficiency.

In one example, a method includes determining a first set of support pixels used to interpolate a value for a first sub-integer pixel position of a pixel of a reference block of video data, determining a second, different set of support pixels used to interpolate a value for a second sub-integer pixel position of the pixel, determining a third, different set of support pixels used to interpolate a value for a third sub-integer pixel position of the pixel, combining corresponding values from the first, second, and third sets of support pixels, applying an interpolation filter to the combined values to calculate a value for a fourth one-eighth-pixel position of the pixel, and coding a portion of a current block of the video data relative to the fourth one-eighth-integer pixel position of the reference block.

In another example, an apparatus includes a video coder configured to determine a first set of support pixels used to interpolate a value for a first sub-integer pixel position of a pixel of a reference block of video data, determine a second, different set of support pixels used to interpolate a value for a second sub-integer pixel position of the pixel, determine a third, different set of support pixels used to interpolate a value for a third sub-integer pixel position of the pixel combine corresponding values from the first, second, and third sets of support pixels, apply an interpolation filter to the combined values to calculate a value for a fourth one-eighth-pixel position of the pixel and code a portion of a current block of the video data relative to the fourth one-eighth-integer pixel position of the reference block.

In another example, an apparatus includes means for determining a first set of support pixels used to interpolate a value for a first sub-integer pixel position of a pixel of a reference block of video data, means for determining a second, different set of support pixels used to interpolate a value for a second sub-integer pixel position of the pixel, means for determining a third, different set of support pixels used to interpolate a value for a third sub-integer pixel position of the pixel, means for combining corresponding values from the first, second, and third sets of support pixels, means for applying an interpolation filter to the combined values to calculate a value for a fourth one-eighth-pixel position of the pixel, and means for coding a portion of a current block of the video data relative to the fourth one-eighth-integer pixel position of the reference block.

In another example, a computer program product includes a computer-readable storage medium having stored thereon instructions that, when executed, cause a processor of a device for coding video data to determine a first set of support pixels used to interpolate a value for a first sub-integer pixel position of a pixel of a reference block of video data, determine a second, different set of support pixels used to interpolate a value for a second sub-integer pixel position of the pixel, determine a third, different set of support pixels used to interpolate a value for a third sub-integer pixel position of the pixel, combine corresponding values from the first, second, and third sets of support pixels, apply an interpolation filter to the combined values to calculate a value for a fourth one-eighth-pixel position of the pixel, and code a portion of a current block of the video data relative to the fourth one-eighth-integer pixel position of the reference block.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating one example of a video encoding and decoding system consistent with the techniques of this disclosure.

FIG. 2 is a block diagram illustrating one example of a video encoder consistent with the techniques of this disclosure.

FIG. 3 is a block diagram illustrating one example of a video decoder consistent with the techniques of this disclosure.

FIG. 4 is a conceptual diagram illustrating different examples of pixel support.

FIG. 5 is a conceptual diagram illustrating one example of one-eighth sub-pixel interpolation.

FIG. 6 is a conceptual diagram illustrating another example of one-eighth sub-pixel interpolation.

FIG. 7 is a conceptual diagram illustrating another example of one-eighth sub-pixel interpolation.

FIG. 8 is a conceptual diagram illustrating another example of one-eighth sub-pixel interpolation.

FIG. 9 is a conceptual diagram illustrating another example of one-eighth sub-pixel interpolation.

FIG. 10 is a conceptual diagram illustrating another example of one-eighth sub-pixel interpolation.

FIG. 11 is a conceptual diagram illustrating another example of one-eighth sub-pixel interpolation.

FIG. 12 is a flowchart that illustrates one example method consistent with the techniques of this disclosure for one-eighth sub-pixel interpolation.

FIG. 13 is a flowchart that illustrates one example method consistent with the techniques of this disclosure for one-eighth sub-pixel interpolation.

FIG. 14 is a flowchart illustrating an example method for one-eighth sub-pixel interpolation.

### DETAILED DESCRIPTION

In general, this disclosure describes techniques for interpolating one-eighth sub-pixel values, sometimes referred to as fractional pixel values, for motion vectors used to encode blocks of video data. The term “eighth-pixel” precision in this disclosure is intended to refer to precision of one-eighth (⅛^{th}) of a pixel, for example, one of: the full pixel position ( 0/8), one-eighth of a pixel (⅛), two-eighths of a pixel ( 2/8, also one-quarter of a pixel), three-eighths of a pixel (⅜), four-eighths of a pixel ( 4/8, also one-half of a pixel and two-quarters of a pixel), five-eighths of a pixel (⅝), six-eighths of a pixel ( 6/8, also three-quarters of a pixel), or seven-eighths of a pixel (⅞). In this manner, motion vectors may have one-eighth pixel precision.

A video sequence includes one or more frames or pictures. Each of the pictures may be divided into one or more blocks, each of which may be individually coded. Encoded blocks of video data may include an indication of how to form prediction data and may include residual data. A video encoder may produce the prediction data during an intra-prediction mode or an inter-prediction mode. Intra-prediction generally involves predicting a block of a picture relative to neighboring, previously coded blocks of the same picture, but does not involve the techniques of this disclosure. Inter-prediction generally involves predicting a block of a picture relative to data of a previously coded picture.

In inter-prediction, a video encoder performs motion estimation and motion compensation to form a predictive block. In motion compensation a video encoder may determine a motion vector which indicates the location of a predicted block relative to the location of another block in a reference frame. The motion vector indicates the location of the reference block relative to the position of the current block. The motion vector may have an x-component, y-component or both, and may use sub-integer pixel precision, for example one-eighth pixel precision, to indicate the location of the predictive block relative to the current block at a sub-pixel level. The video encoder may interpolate values of sub-pixel positions using various interpolation filters, which may be applied to various sets of support.

To determine the location of a reference block that closely matches the current block relative to a reference block, a video encoder may utilize various block matching or pixel searching algorithms which may attempt to find a predictive block that may closely match the current block. This process may be referred to as motion estimation for inter-prediction, and may produce a motion vector that may have sub-integer pixel precision. The video encoder may perform the motion estimation process relative to values that were previously calculated for the sub-integer pixels or may calculate values for the sub-integer pixels on the fly during the motion estimation process.

Following motion estimation, the video encoder may perform a motion compensation process. During motion compensation, a video encoder may retrieve (or calculate) a predictive block for the actual block, based on the motion vector calculated during motion estimation. When a motion vector utilizes sub-pixel precision, a video coding device may interpolate sub-integer pixel values of the predictive and actual blocks in accordance with the techniques of this disclosure. More particularly, a video coding device may implement these techniques to interpolate values for one-eighth pixel positions of a block of video data relative to two or more other interpolated sub-integer pixels, referred to as reference sub-pixels.

Following intra- or inter-prediction to form a predictive block, a video encoder may calculate a residual block for the uncoded block. The residual value generally corresponds to pixel by pixel differences between coefficients of the predictive block and the original, uncoded block.

Likewise, a video decoder may use information indicative of a prediction mode included in a coded bitstream to form prediction data for coded blocks. The data may further include a precision of the motion vector, as well as an indication of a fractional pixel position to which the motion vector points (for example, a one-eighth pixel position of a reference frame or reference slice).

A video coding device, such as a video encoder or a video decoder, may interpolate values for sub-integer pixel positions of a unit of video data (such as a frame, slice, or block) in accordance with the techniques of this disclosure. More particularly, a video coding device may implement these techniques to interpolate values for one-eighth pixel positions of a block of video data relative to two or more other interpolated sub-integer pixels, referred to as reference sub-integer pixels. The video coding device may calculate values for the reference sub-integer pixels using a common interpolation filter applied to different sets of support, combine corresponding values from these sets of support, and apply the same filter to the combined sets of support to calculate values for another sub-integer pixel.

In this manner, the video coding device need only store coefficients for one interpolation filter that may be used to calculate values for at least three different sub-integer pixels. Accordingly, the techniques of this disclosure may allow for a reduction in the number of interpolation filters that are stored for interpolating values for one-eighth-pixel positions, which may reduce storage requirements for video coding devices, thus allowing fewer memory accesses, reducing memory access time, relative to storing interpolation filters for each sub-integer pixel position. The techniques of this disclosure may also allow for a reduction in the complexity and/or number of mathematical operations that a video coding device performs for interpolating values for one-eighth pixel positions, which may also reduce the speed, power consumption, processing time, or memory access time. The techniques of this disclosure may thereby potentially reduce processing time and/or battery consumption of mobile devices including video coding units implemented according to these techniques.

As discussed above, the techniques of this disclosure may be performed during an inter-prediction portion of a coding process. Following intra- or inter-prediction, a video encoder may calculate a residual value for the block. The residual value generally corresponds to the difference between the predicted data for the block and the true value of the block. To further compress the residual value of a block, the residual value may be transformed into a set of transform coefficients that compact as much data (also referred to as “energy”) as possible into as few coefficients as possible. The transform coefficients correspond to a two-dimensional matrix of coefficients that may be the same size as the original block. In other words, there may be as many transform coefficients as pixels in the original block. However, due to the transform, many of the transform coefficients may have values equal to zero.

The video encoder may then quantize the transform coefficients to further compress the video data. Quantization generally involves mapping values within a relatively large range to values in a relatively small range, thus reducing the amount of data needed to represent the quantized transform coefficients. Following quantization, the video encoder may scan the transform coefficients, producing a one-dimensional vector from the two-dimensional matrix including the quantized transform coefficients. Because there may be several zero-value quantized transform coefficients, the video encoder may be configured to stop the scan upon reaching a zero-valued quantized transform coefficient, thus reducing the number of coefficients in the one-dimensional vector. The scan may be designed to place higher energy (and therefore lower frequency) coefficients at the front of the array and to place lower energy (and therefore higher frequency) coefficients at the back of the array.

The video encoder may then entropy encode the resulting array, to even further compress the data. In some examples, the video encoder may be configured to use variable length codes (VLCs) to represent various possible quantized transform coefficients of the array according to context-adaptive variable-length coding (CAVLC). The video encoder may also be configured to use binary arithmetic coding to encode the resulting quantized coefficients according to context-adaptive binary arithmetic coding (CABAC).

This disclosure describes several techniques related to inter-predictive coding, more specifically to supporting one-eighth sub-pixel precision. The techniques of this disclosure may be performed during a coding process performed by a video coding device, such as a video encoder or a video decoder. In this disclosure, the term “coding” refers to encoding that occurs at the encoder or decoding that occurs at the decoder. Similarly, the term coder refers to an encoder, a decoder, or a combined encoder/decoder (CODEC). The terms coder, encoder, decoder and CODEC all refer to specific machines designed for the coding (encoding and/or decoding) of video data consistent with this disclosure.

Efforts are currently in progress to develop a new video coding standard, currently referred to as High Efficiency Video Coding (HEVC). The upcoming standard is also referred to as H.265. The standardization efforts are based on a model of a video coding device referred to as the HEVC Test Model (HM). The HM presumes several capabilities of video coding devices over devices according to, previous coding standards, such as ITU-T H.264/AVC. For example, whereas H.264 provides nine intra-prediction encoding modes, HM provides as many as thirty-four intra-prediction encoding modes.

HM refers to a block of video data as a coding unit (CU). Syntax data within a bitstream may define a largest coding unit (LCU), which is a largest coding unit in terms of the number of pixels. In general, a CU has a similar purpose to a macroblock of H.264, except that a CU does not have a size distinction. Thus, a CU may be split into sub-CUs. In general, references in this disclosure to a CU may refer to a largest coding unit of a picture or a sub-CU of an LCU. An LCU may be split into sub-CUs, and each sub-CU may be split into sub-CUs. Syntax data for a bitstream may define a maximum number of times an LCU may be split, referred to as CU depth. Accordingly, a bitstream may also define a smallest coding unit (SCU). This disclosure also uses the term “block” to refer to any of a CU, PU, or TU in instances corresponding to HEVC.

An LCU may be associated with a quadtree data structure. In general, a quadtree data structure includes one node per CU, where a root node corresponds to the LCU. If a CU is split into four sub-CUs, the node corresponding to the CU includes four leaf nodes, each of which corresponds to one of the sub-CUs. Each node of the quadtree data structure may provide syntax data for the corresponding CU. For example, a node in the quadtree may include a split flag, indicating whether the CU corresponding to the node is split into sub-CUs. Syntax elements for a CU may be defined at leach level of the quadtree structure, and may depend on whether the CU is split into sub-CUs.

A CU that is not split may include one or more prediction units (PUs). In general, a PU represents all or a portion of the corresponding CU, and includes data for retrieving a reference sample for the PU. For example, when the PU is intra-mode encoded, the PU may include data describing an intra-prediction mode for the PU. As another example, when the PU is inter-mode encoded, the PU may include data defining a motion vector for the PU. The data defining the motion vector may describe, for example, a horizontal component of the motion vector, a vertical component of the motion vector, a resolution for the motion vector (for example, one-quarter pixel precision or one-eighth pixel precision), a reference frame to which the motion vector points, and/or a reference list (for example, list 0 or list 1) for the motion vector. Data for the CU defining the PU(s) may also describe, for example, partitioning of the CU into one or more PUs. Partitioning modes may differ between whether the CU is uncoded, intra-prediction mode encoded, or inter-prediction mode encoded.

A CU having one or more PUs may also include one or more transform units (TUs). Following prediction using a PU, a video encoder may calculate a residual value for the portion of the CU corresponding to the PU. The residual value may be transformed, scanned, and quantized. A TU is not necessarily limited to the size of a PU. Thus, TUs may be larger or smaller than corresponding PUs for the same CU. In some examples, the maximum size of a TU may correspond to the size of the corresponding CU.

Devices implementing the techniques of HM may code motion vectors for intra-prediction coding with one-eighth pixel resolution. In some instances, eighth-pixel motion vectors with may provide improve prediction accuracy over lower-resolution, for example, one-quarter or one-half pixel, motion vectors. Increased prediction accuracy may reduce the amount of data that is coded in residual blocks and thereby improve overall video coding efficiency. Previous standards such as by MPEG-2, MPEG-4, ITU-T H.263, and ITU-T H.264 do not support one-eighth pixel precision motion vectors, providing instead for one-half or one-quarter pixel motion vectors precision.

In addition to supporting one-half and one-quarter pixel precision vectors as in previous video coding standards, devices complaint with HM may support motion vectors having one-eighth sub-pixel resolution. A device compliant with HM may support adaptive motion vector resolution. That is, an HM compliant device may select the motion vector precision on a CU-by-CU basis. The selection of motion vector precision may be made in a way such that the tradeoff between using a higher precision motion vector which requires more bits to code the vector, and coding a lower amount of residual data from more accurately calculating a predictive block using a finer sub-pixel precision, may reduce video bitrate. For a coding device to utilize one-eighth pixel interpolation in video coding, the device interpolates values for one-eighth pixel positions that may potentially be used for reference. This disclosure describes coding techniques for supporting the use of motion vectors having eighth-pixel precisions.

As examples of techniques an HM-compatible device may use to interpolate eighth-pixel values, an HM-compatible video coding device may interpolate eighth-pixel values using bilinear interpolation or using an N-tap finite response filter (FIR). A motion vector having a particular sub-pixel precision may refer to sub-pixels at locations corresponding to that sub-pixel precision. Therefore, a video encoding device may calculate values for sub-pixels corresponding to that sub-pixel precision for motion estimation and motion compensation, and a video decoding device may calculate values for the sub-pixels during motion compensation based on a received motion vector of the sub-pixel precision. For example, a one-eighth pixel motion vector may refer to interpolated eighth-pixel values, and a one-quarter pixel motion vector may refer to interpolated quarter-pixel values.

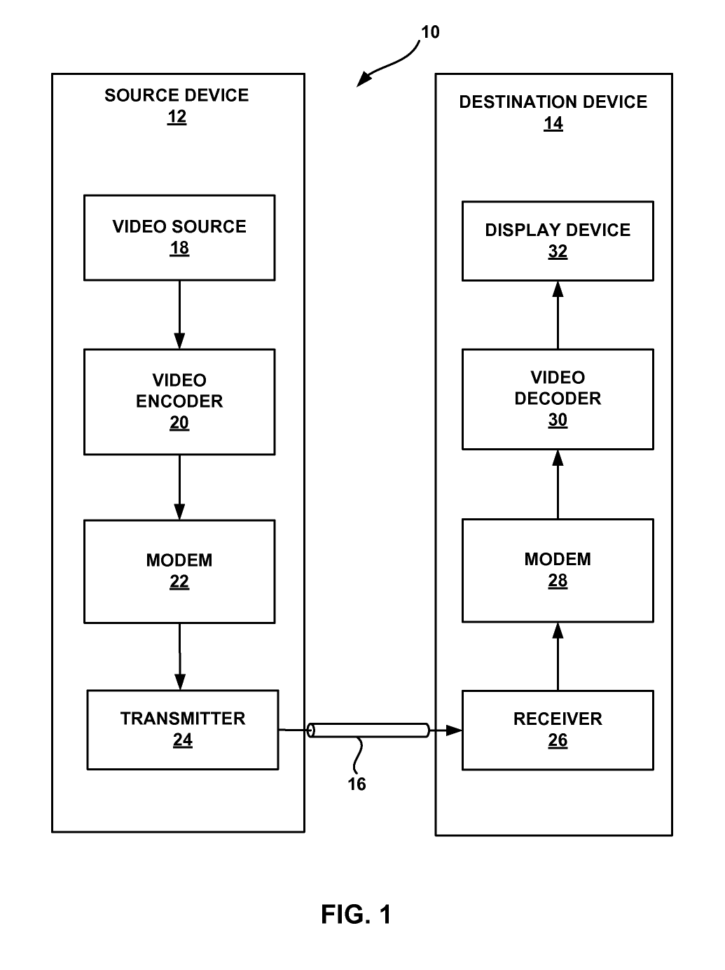

FIG. 1 is a block diagram illustrating an example video encoding and decoding system 10 that may utilize techniques for supporting one-eighth pixel motion vectors. As shown in FIG. 1, system 10 includes a source device 12 that transmits encoded video to a destination device 14 via a communication channel 16. Source device 12 and destination device 14 may comprise any of a wide range of devices. In some cases, source device 12 and destination device 14 may comprise wireless communication devices, such as wireless handsets, so-called cellular or satellite radiotelephones, or any wireless devices that can communicate video information over a communication channel 16, in which case communication channel 16 is wireless.

The techniques of this disclosure, however, which concern coding techniques for supporting the use of motion vectors having eighth-pixel precision, are not necessarily limited to wireless applications or settings. For example, these techniques may apply to over-the-air television broadcasts, cable television transmissions, satellite television transmissions, Internet video transmissions, encoded digital video that is encoded onto a storage medium, or other scenarios. Accordingly, communication channel 16 may comprise any combination of wireless or wired media suitable for transmission of encoded video data.

In the example of FIG. 1, source device 12 includes a video source 18, video encoder 20, a modulator/demodulator (modem) 22 and a transmitter 24. Destination device 14 includes a receiver 26, a modem 28, a video decoder 30, and a display device 32. In accordance with this disclosure, video encoder 20 of source device 12 may be configured to apply the techniques for supporting the use of motion vectors having eighth-pixel precision. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Coding techniques for supporting the use of motion vectors having eighth-pixel precision may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, for example, for video streaming, video playback, video broadcasting, or video telephony.

Video source 18 of source device 12 may include a video capture device, such as a video camera, a video archive containing previously captured video, and/or a video feed from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be modulated by modem 22 according to a communication standard, and transmitted to destination device 14 via transmitter 24. Modem 22 may include various mixers, filters, amplifiers or other components designed for signal modulation. Transmitter 24 may include circuits designed for transmitting data, including amplifiers, filters, and one or more antennas.

Receiver 26 of destination device 14 receives information over channel 16, and modem 28 demodulates the information. Again, the video encoding process may implement one or more of the techniques described herein to implement coding techniques for supporting the use of motion vectors having eighth-pixel precision. The information communicated over channel 16 may include syntax information defined by video encoder 20, which is also used by video decoder 30, that includes syntax elements that describe characteristics and/or processing of LCUs and other coded units, for example, GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

In the example of FIG. 1, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

Video encoder 20 and video decoder 30 may operate according to a video compression standard, such as the ITU-T H.264 standard, alternatively referred to as MPEG-4, Part 10, Advanced Video Coding (AVC) or according to HM. The techniques of this disclosure, however, are not limited to any particular coding standard. Other examples include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 30 may be included in one or more encoders or decoders, either of which may be integrated as part of a combined encoder/decoder (CODEC) in a respective camera, computer, mobile device, subscriber device, broadcast device, set-top box, server, or the like.

A video sequence typically includes a series of video frames. A group of pictures (GOP) generally comprises a series of one or more video frames. A GOP may include syntax data in a header of the GOP, a header of one or more frames of the GOP, or elsewhere, that describes a number of frames included in the GOP. Each frame may include frame syntax data that describes an encoding mode for the respective frame. Video encoder 20 typically operates on video blocks, also referred to as CUs, within individual video frames in order to encode the video data. A video block may correspond to an LCU or a partition of an LCU. The video blocks may have fixed or varying sizes, and may differ in size according to a specified coding standard. Each video frame may include a plurality of slices. Each slice may include a plurality of LCUs, which may be arranged into partitions, also referred to as sub-CUs.

As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16×16, 16×8, 8×16, 8×8, 8×4, 4×8 and 4×4 for luma components and corresponding scaled sizes for chroma components. In this disclosure, “N×N” and “N by N” may be used interchangeably to refer to the pixel dimensions of the block in terms of vertical and horizontal dimensions, for example, 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N. Block sizes that are less than 16 by 16 may be referred to as partitions of a 16 by 16 macroblock.

In accordance with the techniques of this disclosure, a coding device (also referred to generally as a video coder), such as video encoder 20 and/or video decoder 30, may be configured to determine a first, second, and third set of support pixels used to interpolate values for first, second, and third, sub-integer pixel positions (such as one-quarter or one-eighth pixel positions) of a pixel of a reference block of video data. The coding device may also combine the corresponding values from the first, second, and third sets of support pixels, apply an interpolation filter to the combined support values to calculate a value for a fourth sub-pixel position, comprising a one-eighth pixel position, of the pixel, and code a portion of a current block of the video data relative to the fourth sub-pixel position of the reference block.

In performing the techniques of this disclosure, the interpolation filter may comprise a one-dimensional interpolation filter. Additionally, the calculated value for the fourth sub-pixel position may approximate an average of a value for the second sub-integer pixel position, a value for the third sub-integer pixel position, and two times a value for the first sub-integer pixel position. Also, coding the portion of the current block of the video data relative to the fourth sub-integer pixel position of the reference block may also comprise calculating a residual value for the current block as a difference between the reference block and the current block while encoding the current block. The video coding device may additionally be configured such that the reference block comprises calculating a reconstructed value for the current block as the sum of the reference block and a received residual value for the current block while decoding the current block.

In accordance with the techniques of this disclosure, a coding device (also referred to generally as a video coder), such as video encoder 20 and/or video decoder 30, may be configured to apply an interpolation filter to a first set of supporting pixels and store the result as a first value. The coding device may also be configured to apply the same interpolation filter to a second set of supporting pixels to calculate a value for a second, different one-eighth pixel, and store the value as a second value. The first one-eighth pixel position, and the second one-eighth pixel position may form a horizontal, vertical, or diagonal line. The video coding device may then average the first and second values to calculate a value for a third sub-integer pixel position, e.g., a third one-eighth pixel position, or otherwise calculate a value for the third sub-integer pixel position that approximates an average of (or other computational combination of) the first and second sub-integer pixel positions. As noted above, the term “video coder” may refer to a video coding device, such as a video encoder, a video decoder, a video encoder/decoder (CODEC), a set of instructions for encoding and/or decoding video data during execution by a processor or processing unit, or other devices including hardware (potentially also including software or firmware) configured to encode and/or decode video data.

As another example in accordance with the techniques of this disclosure, a video coding device, such as video encoder 20 and/or video decoder 30, may be configured in the manner described above, but may also apply an interpolation filter to the third set of supporting pixels to calculate a third, different eighth-pixel value, and store the value as a third value. The coding device may calculate a fourth one-eighth pixel position, which forms one of a positive forty-five degree line, and a negative forty-five degree line. The coding device may calculate the forth one-eighth pixel position by averaging twice the value the for the first one-eighth pixel position, the value for the second one-eighth pixel position, and the value for the third one-eighth pixel position. Video encoder 20 and video decoder 30 may perform these techniques during inter-prediction to interpolate values for sub-integer pixel positions.

In some examples, the video coding device may be configured to calculate values for the sub-integer pixels that are ultimately averaged, without rounding. That is, the video coding device may round the values only after averaging the values, to reduce error introduced by rounding earlier. Values used for reference may correspond to rounded values. For example, the values calculated for the first and second one-eighth pixel positions discussed above may correspond to rounded values, but the values used for averaging to calculate the value for the third one-eighth pixel position may be unrounded.

Video blocks may comprise blocks of pixel data in the pixel domain, or blocks of transform coefficients in the transform domain, for example, following application of a transform such as a discrete cosine transform (DCT), an integer transform, a wavelet transform, or a conceptually similar transform to the residual video block data representing pixel differences between coded video blocks and predictive video blocks. In some cases, a video block may comprise blocks of quantized transform coefficients in the transform domain.

Smaller video blocks can provide better resolution, and may be used to code regions of a video frame that include high levels of detail. In general, LCUs and the various partitions, sometimes referred to as sub-CUs, may be considered video blocks. In addition, a slice may be considered to be a plurality of video blocks, such as LCUs and/or sub-CUs. Each slice may be an independently decodable unit of a video frame. Alternatively, frames themselves may be decodable units, or other portions of a frame may be defined as decodable units. The term “coded unit” or “coding unit” may refer to any independently decodable unit of a video frame such as an entire frame, a slice of a frame, a group of pictures (GOP) also referred to as a sequence, or another independently decodable unit defined according to applicable coding techniques.

Following intra-predictive or inter-predictive coding to produce predictive data and residual data, and following any transforms (such as the 4×4 or 8×8 integer transform used in H.264/AVC or a discrete cosine transform DCT) to produce transform coefficients, a video coding device may quantize the transform coefficients. Quantization generally refers to a process in which transform coefficients are quantized to possibly reduce the amount of data used to represent the coefficients. The quantization process may reduce the bit depth associated with some or all of the coefficients. For example, an n-bit value may be rounded down to an m-bit value during quantization, where n is greater than m.

Following quantization, entropy coding of the quantized data may be performed, for example, according to content adaptive variable length coding (CAVLC), context adaptive binary arithmetic coding (CABAC), or another entropy coding methodology. A processing unit configured for entropy coding, or another processing unit, may perform other processing functions, such as zero run length coding of quantized coefficients and/or generation of syntax information such as coded block pattern (CBP) values, LCU type, coding mode, LCU size for a coded unit (such as a frame, slice, LCU, or sequence), or the like.

Video encoder 20 may further send syntax data, such as block-based syntax data, frame-based syntax data, and GOP-based syntax data, to video decoder 30, for example, in a frame header, a block header, a slice header, or a GOP header. The GOP syntax data may describe a number of frames in the respective GOP, and the frame syntax data may indicate an encoding/prediction mode used to encode the corresponding frame.

Video decoder 30 may be configured to perform a decoding process that substantially conforms to a reciprocal process to the video encoding process described with respect to video encoder 20. Video decoder 30 may utilize received motion vectors of a particular precision pointing to a particular sub-integer pixel position, and utilize the techniques described above to calculate a value for the sub-integer pixel position, in some examples. That is, video decoder 30 may be configured with interpolation filters and support definitions for certain sub-integer pixel positions and calculate values for two sub-integer pixel positions using the same interpolation filter applied to two different sets of support. Video decoder 30 may then calculate a value for a third sub-integer pixel position (e.g., the position pointed to by the received motion vector) by averaging the calculated values of the other sub-integer pixel positions.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). An apparatus including video encoder 20 and/or video decoder 30 may comprise an integrated circuit, a microprocessor, and/or a wireless communication device, such as a cellular telephone.

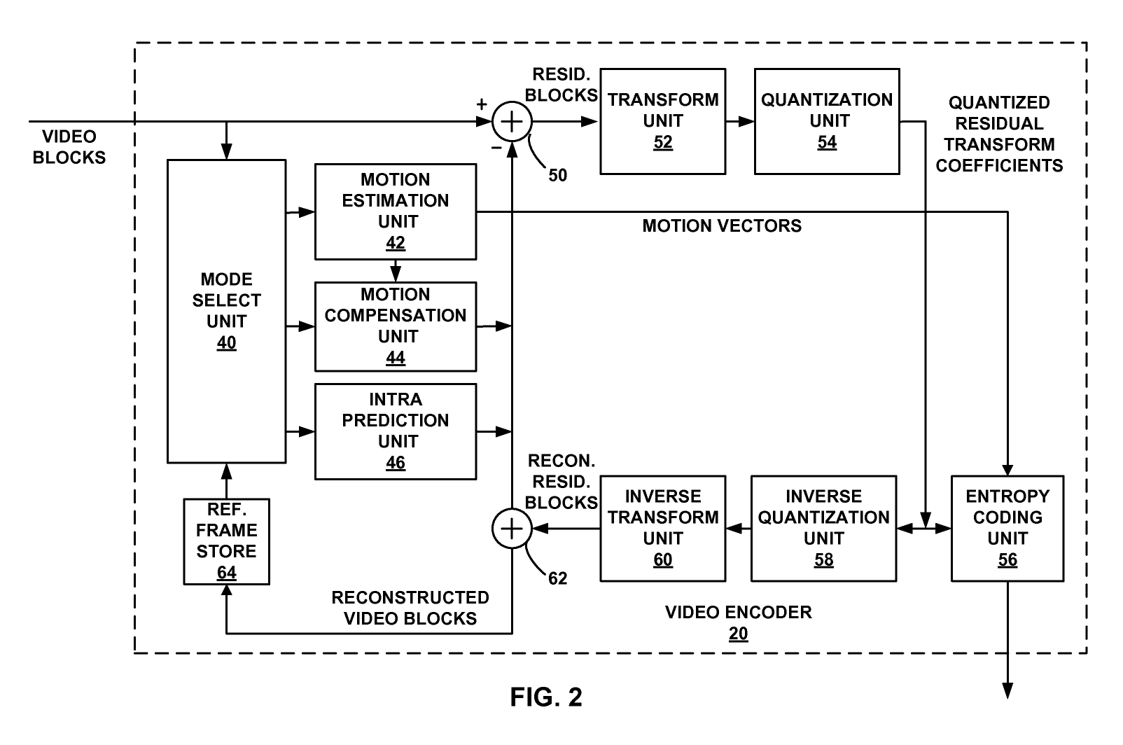

FIG. 2 is a block diagram illustrating an example of video encoder 20 that may implement inter-predictive coding techniques for supporting the use of motion vectors having eighth-pixel (⅛^{th} of a pixel) precision. Video encoder 20 may perform intra- and inter-coding of blocks within video frames, including LCUs, or partitions or sub-CUs of LCUs. Intra-coding relies on spatial prediction to reduce or remove spatial redundancy in video within a given video frame. Inter-coding relies on temporal prediction to reduce or remove temporal redundancy in video within adjacent frames of a video sequence. Intra-mode (I-mode) may refer to any of several spatial based compression modes and inter-modes such as uni-directional prediction (P-mode) or bi-directional prediction (B-mode) may refer to any of several temporal-based compression modes.

As shown in FIG. 2, video encoder 20 receives a current video block within a video frame to be encoded. In the example of FIG. 2, video encoder 20 includes motion compensation unit 44, motion estimation unit 42, reference frame store 64, summer 50, transform unit 52, quantization unit 54, and entropy coding unit 56. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62.

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal compression. Intra prediction unit 46 may, alternatively, perform intra-predictive coding of the received video block relative to one or more neighboring blocks in the same frame or slice as the block to be coded to provide spatial compression, for example, when mode select unit 40 indicates that the block should be intra-prediction coded.

Mode select unit 40 may select one of the coding modes, intra or inter, for example, based on error results, and provides the resulting intra- or inter-prediction block to summer 50 to generate residual block data and to summer 62 to reconstruct the encoded block for use as a reference frame.

Motion estimation unit 42 and motion compensation unit 44 may be highly integrated, but are illustrated separately for conceptual purposes. Motion estimation is the process of generating motion vectors, which estimate motion for video blocks. As stated above, devices implementing the techniques of HM may utilize motion vectors with eighth-pixel precision. A motion vector, for example, may indicate the location of a predictive block relative to the location of a block in another frame or slice, such as a reference frame or reference slice. A predictive block is a block that may closely match the block to be coded, in terms of pixel difference, which may be determined by sum of absolute difference (SAD), sum of square difference (SSD), or other difference metrics. A motion vector may also indicate the location of a sub-CU of an LCU within a reference block. Motion compensation may involve fetching or generating the predictive block based on the motion vector determined by motion estimation. Again, motion estimation unit 42 and motion compensation unit 44 may be functionally integrated, in some examples.

Motion estimation unit 42 calculates a motion vector for the video block of an inter-coded frame by comparing the video block to video blocks of a reference frame in reference frame store 64. An element of video encoder 20, such as motion compensation unit 44, may also interpolate values for sub-integer pixels of a reference frame to be stored in reference frame store 64. Alternatively, motion estimation unit 42 may interpolate values for a reference frame stored in reference frame store 64 on the fly, that is, during the motion search. For purposes of example, motion compensation unit 44 is described as interpolating values for sub-integer pixels, although it should be understood that other elements of video encoder 20 may be configured to interpolate these values in other examples.

In order to interpolate sub-integer pixels of the reference frame, motion compensation unit 44 may utilize a variety of techniques. As examples, motion compensation unit 44 may utilize bilinear interpolation or utilize N-tap finite response filters (FIRs) to interpolate a sub-integer pixel. When a device such as motion compensation unit 44 calculates a value for a fractional pixel by averaging two pixels or sub-pixels, it may round, and/or scale the resulting value. In some cases, motion compensation unit 44 may average values for two sub-pixels which are the result of averaging to a sub-integer pixel. When values for two sub-pixels are calculated from averaging values for other sub-pixels, and are then further averaged, repeated rounding occurring with each average may result in a loss of value precision. Thus, in some cases of such repeated averaging, motion compensation unit 44 defers rounding until the value of the smallest sub-pixel unit has been interpolated in order to avoid loss due to rounding in earlier steps.

In accordance with the techniques of this disclosure, motion compensation unit 44 may calculate values for two or more sub-integer pixel positions, such as one-eighth pixel positions, by applying the same interpolation filter to two or more different sets of support. Support generally refers to values for one or more reference pixels, e.g., pixels in a common line or region. The pixels may correspond to full pixel positions or sub-integer pixel positions that were previously calculated. In some examples, motion compensation unit 44 may calculate values for sub-integer pixels using bilinear interpolation, and may use similar bilinear interpolation filters to calculate values for two or more different sub-integer pixel positions by applying the one or more of the bilinear interpolation filters to different sets of support for the respective sub-integer pixel positions.

In another example in accordance with the techniques of this disclosure, motion compensation unit 44 may determine a first set of support for a first sub-integer pixel position, a second, different set of support, for a second sub-integer pixel position, and a third, different set of support for a third sub-integer pixel position. Motion compensation unit may combine the corresponding values from the sets of support pixels and apply an interpolation filter to the combined values to calculate the value of a fourth sub-integer pixel position, which may comprise a one-eighth-pixel pixel position. The first, second, and third sub-integer pixel positions may comprise one-quarter or one-eighth pixel positions, in some examples.

In some other cases, motion compensation unit 42 may utilize an N-tap finite response filter (FIR) to interpolate a sub-pixel value. A FIR, such as a 6-tap or 12-tap Wiener filter, may utilize nearby support pixel values to interpolate a sub-integer pixel value. A support pixel is a pixel or sub-pixel value used as an input to the FIR. A FIR may have one or more dimensions. In a one-dimensional FIR, a device such as motion compensation unit 44 may apply a filter to a number of support pixels or sub-pixels in a line, for example, horizontally, vertically, or at an angle. In contrast to a one-dimensional FIR, which may use support pixels in a straight line, a two-dimensional FIR, may use nearby support pixels or sub-pixels which form a square or rectangle to compute the interpolated pixel value. Though a filter may be designed to be applied to sets of support pixels in a particular arrangement, such as a straight line or a rectangle, the arrangement need not necessarily conform to that arrangement.

The resulting value of a FIR calculation of a sub-pixel may be rounded and scaled. Again, when two sub-pixel values are averaged, the repeated rounding occurring with each average may result in a loss of value precision. Thus in some cases of repeated averaging, motion compensation unit 44 defers rounding until the value of the smallest sub-pixel unit has been interpolated in order to retain as much precision as possible.

Generally, motion compensation unit 44 may maintain the same number of support pixels for interpolation of sub-integer pixels. By maintaining the same number of support pixels for each interpolation filter, motion compensation unit 44 may only need to store one interpolation filter rather than storing multiple filters. Storing only one filter may reduce memory usage, improve coding performance, improve power consumption, and/or decrease device complexity.

Motion estimation unit 42 compares blocks of one or more reference frames from reference frame store 64 to a block to be encoded of a current frame, for example, a P-frame or a B-frame. When the reference frames in reference frame store 64 include values for sub-integer pixels, a motion vector calculated by motion estimation unit 42 may refer to a sub-integer pixel location of a reference frame. As discussed above, reference frames in reference frame store 64 may include values for sub-integer pixels calculated in accordance with the techniques of this disclosure. Motion estimation unit 42 and/or motion compensation unit 44 may also be configured to calculate values for sub-integer pixel positions of reference frames stored in reference frame store 64 if no values for sub-integer pixel positions are stored in reference frame store 64. Motion estimation unit 42 sends the calculated motion vector to entropy coding unit 56 and motion compensation unit 44. The reference block identified by a motion vector may be referred to as a predictive block.

Motion compensation unit 44 may calculate prediction data based on the motion vector received from motion estimation unit 42. Video encoder 20 forms a residual video block by subtracting the prediction data from motion compensation unit 44 from the original video block being coded. Summer 50 represents the component or components that perform this subtraction operation. Transform unit 52 applies a transform, such as a discrete cosine transform (DCT) or a conceptually similar transform, to the residual block, producing a video block comprising residual transform coefficient values. Transform unit 52 may perform other transforms, such as those defined by HEVC or the H.264 standard, which are conceptually similar to DCT. Wavelet transforms, integer transforms, sub-band transforms, Karhunen-Loève transforms, or other types of transforms could also be used.

In any case, transform unit 52 applies the transform to the residual block, producing a block of residual transform coefficients. The transform may convert the residual information from a pixel value domain to a transform domain, such as a frequency domain. Quantization unit 54 quantizes the residual transform coefficients to further reduce bit rate. The quantization process may reduce the bit depth associated with some or all of the coefficients. The degree of quantization may be modified by adjusting a quantization parameter.

Following quantization, entropy coding unit 56 entropy codes the quantized transform coefficients. For example, entropy coding unit 56 may perform content adaptive variable length coding (CAVLC), context adaptive binary arithmetic coding (CABAC), or another entropy coding technique. Following the entropy coding by entropy coding unit 56, the encoded video may be transmitted to another device or archived for later transmission or retrieval. In the case of context adaptive binary arithmetic coding, context may be based on neighboring LCUs.

In some cases, entropy coding unit 56 or another unit of video encoder 20 may be configured to perform other coding functions, in addition to entropy coding. For example, entropy coding unit 56 may be configured to determine the CBP values for the LCUs and partitions. Also, in some cases, entropy coding unit 56 may perform run length coding of the coefficients in a LCU or partition thereof. In particular, entropy coding unit 56 may apply a zig-zag scan or other scan pattern to scan the transform coefficients in a LCU or partition and encode runs of zeros for further compression. Entropy coding unit 56 also may construct header information with appropriate syntax elements for transmission in the encoded video bitstream.

Inverse quantization unit 58 and inverse transform unit 60 apply inverse quantization and inverse transformation, respectively, to reconstruct the residual block in the pixel domain, for example, for later use as a reference block. Summer 62 may calculate a reference block by adding the residual block to a predictive block calculated by motion compensation unit 44. Motion compensation unit 44 may also apply one or more interpolation filters to the reconstructed residual block to calculate sub-integer pixel values for use in motion estimation. Summer 62 adds the reconstructed residual block to the motion compensated predictive block produced by motion compensation unit 44 to produce a reconstructed video block for storage in reference frame store 64. The reconstructed video block may be used by motion estimation unit 42 and motion compensation unit 44 as a reference block to inter-code a block in a subsequent video frame.

In this manner, video encoder 20 represents an example of a video coding device, also referred to as a video coder, configured to apply an interpolation filter to a first set of supporting pixels and calculate a result of the filter without rounding the result and store the result as a first value, apply the same interpolation filter to a second, different set of supporting pixels to calculate a value for a second, different one-eighth pixel, and store the value as a second value. The first one-eighth pixel position, and the second one-eighth pixel position may form a horizontal, vertical, or diagonal line, and the calculated value for the one-eighth value of the pixel may approximate an average of the value for the first pixel position and the second pixel position.

In this manner, video encoder 20 represents an example of a video coding device configured in the manner above, but may also apply an interpolation filter to the third set of supporting pixels to calculate a third, different eighth-pixel value, and store the value as a third value. The encoder/decoder may calculate a fourth one-eighth pixel position, which forms one of a positive forty-five degree line, and a negative forty-five degree line. The encoder/decoder may calculate the forth one-eighth pixel position by averaging twice the value the for the first one-eighth pixel position, the value for the second one-eighth pixel position, and the value for the third one-eighth pixel position.

Video encoder 20 may also represent an example of a video coding device configured to determine first, second, and third sets of sub-integer pixel support pixels to interpolate values for first, second, and third sub-integer pixel positions of a pixel of a reference block of video data. The video encoder/decoder may combine the corresponding values from the first, second, and third sets of support pixels and apply an interpolation filter to the combined values to calculate a value for a fourth sub-integer pixel position, e.g., a one-eighth pixel position, of the pixel. The encoder/decoder may code a portion of a current block of the video data relative to the fourth one-eighth-pixel position of the reference block. In some cases, the value for the fourth one-eighth-pixel position may approximate an average of twice a value for the first sub-integer pixel position, a value for the second sub-integer pixel position, and a value for the third sub-integer-pixel position.

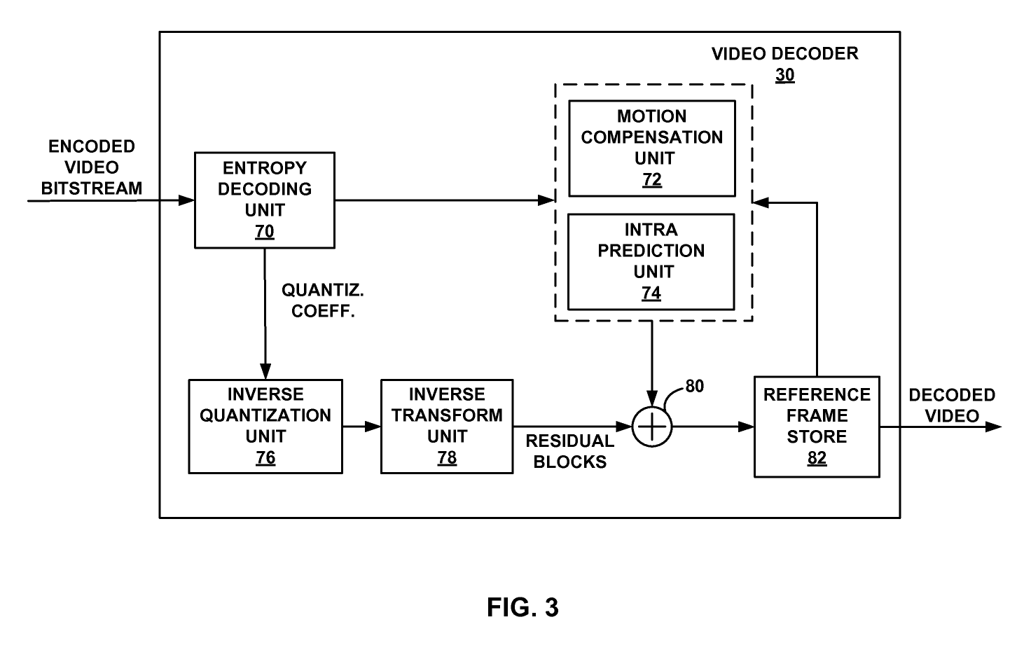

FIG. 3 is a block diagram illustrating an example of video decoder 30, which decodes an encoded video sequence. In the example of FIG. 3, video decoder 30 includes an entropy decoding unit 70, motion compensation unit 72, intra prediction unit 74, inverse quantization unit 76, inverse transformation unit 78, reference frame store 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70.

Motion compensation unit 72 may use motion vectors received in the bitstream to identify a predictive block in reference frames in reference frame store 82. In a device supporting the techniques of HM, those vectors may have one-eighth pixel precision. According to the techniques of this disclosure, motion compensation unit 72 may be configured to calculate values for sub-integer pixels by applying an interpolation filter to a first set of support and a second set of support, and to average these values to produce the value for a particular sub-integer pixel. In an example of one-eighth-pixel interpolation, motion compensation unit 72 may to determine first, second, and third sets of sub-integer support pixels to interpolate values for first, second, and third sub-integer pixel positions of a pixel of a reference block of video data. The video encoder/decoder may combine the corresponding values from the first, second, and third sets of support pixels and apply an interpolation filter to the combined values to calculate a value for a fourth sub-integer pixel position comprising a one-eighth pixel position of the pixel.

Intra prediction unit 74 may use intra prediction modes received in the bitstream to form a predictive block from spatially adjacent blocks. Inverse quantization unit 76 inverse quantizes, that is, de-quantizes, the quantized block coefficients provided in the bitstream and decoded by entropy decoding unit 70. The inverse quantization process may include a conventional process, for example, as defined by the H.264 decoding standard. The inverse quantization process may also include use of a quantization parameter QP_{Y} calculated by encoder 50 for each LCU to determine a degree of quantization and, likewise, a degree of inverse quantization that should be applied.

Inverse transform unit 58 applies an inverse transform, for example, an inverse DCT, an inverse integer transform, or a conceptually similar inverse transform process, to the transform coefficients in order to produce residual blocks in the pixel domain. Motion compensation unit 72 produces motion compensated blocks, possibly performing interpolation based on interpolation filters. Identifiers for interpolation filters to be used for motion compensation with sub-pixel precision may be included in the syntax elements. Motion compensation unit 72 may use interpolation filters as used by video encoder 20 during encoding of the video block to calculate interpolated values for sub-integer pixels of a reference block. Motion compensation unit 72 may determine the interpolation filters used by video encoder 20 according to received syntax information and use the interpolation filters to produce predictive blocks. As examples, motion compensation unit 72 may use interpolation filters such as N-tap Wiener filters, and averaging techniques discussed above, as well as other filters, to produce predictive blocks.

Motion compensation unit 72 uses some of the syntax information to determine sizes of LCUs used to encode frame(s) of the encoded video sequence, partition information that describes how each LCU of a frame of the encoded video sequence is partitioned, modes indicating how each partition is encoded, one or more reference frames (and reference frame lists) for each inter-encoded LCU or partition, and other information to decode the encoded video sequence.

Summer 80 sums the residual blocks with the corresponding predictive blocks generated by motion compensation unit 72 or intra-prediction unit to form decoded blocks. If desired, a deblocking filter may also be applied to filter the decoded blocks in order to remove blockiness artifacts. The decoded video blocks are then stored in reference frame store 82, which provides reference blocks for subsequent motion compensation and also produces decoded video for presentation on a display device (such as display device 32 of FIG. 1).

In this manner, video decoder 30 represents an example of a video coding device configured to apply an interpolation filter to a first set of supporting pixels, apply the interpolation filter to a second, different set of supporting pixels, calculate a value for a one-eighth pixel position of a pixel of a reference block of video data as an average of the first and second intermediate values resulting from application of the interpolation filter to the first set of supporting pixels and the second set of supporting pixels, and code a portion of a current block of the video data relative to the one-eighth pixel position of the reference block.

In this manner, video decoder 30 represents an example of a video coding device configured in the manner above, but may also apply an interpolation filter to the third set of supporting pixels to calculate a third, different eighth-pixel value, and store the value as a third value. The encoder/decoder may calculate a fourth one-eighth pixel position, which forms one of a positive forty-five degree line, and a negative forty-five degree line. The encoder/decoder may calculate the forth one-eighth pixel position by averaging twice the value the for the first one-eighth pixel position, the value for the second one-eighth pixel position, and the value for the third one-eighth pixel position.

Video decoder 20 may also represent an example of a video coding device configured to determine first, second, and third sets of support pixels to interpolate values for first, second, and third sub-integer pixel positions of a pixel of a reference block of video data. The video encoder/decoder may combine the corresponding values from the first, second, and third sets of support pixels and apply an interpolation filter to the combined values to calculate a value for a fourth sub-integer pixel position comprising a one-eighth pixel position of the pixel. The encoder/decoder may code a portion of a current block of the video data relative to the fourth sub-integer pixel position of the reference block. In some cases, the value for the fourth sub-integer pixel position may approximate an average of twice a value for the first sub-integer pixel position, a value for the second sub-integer pixel position, and a value for the third sub-integer pixel position.

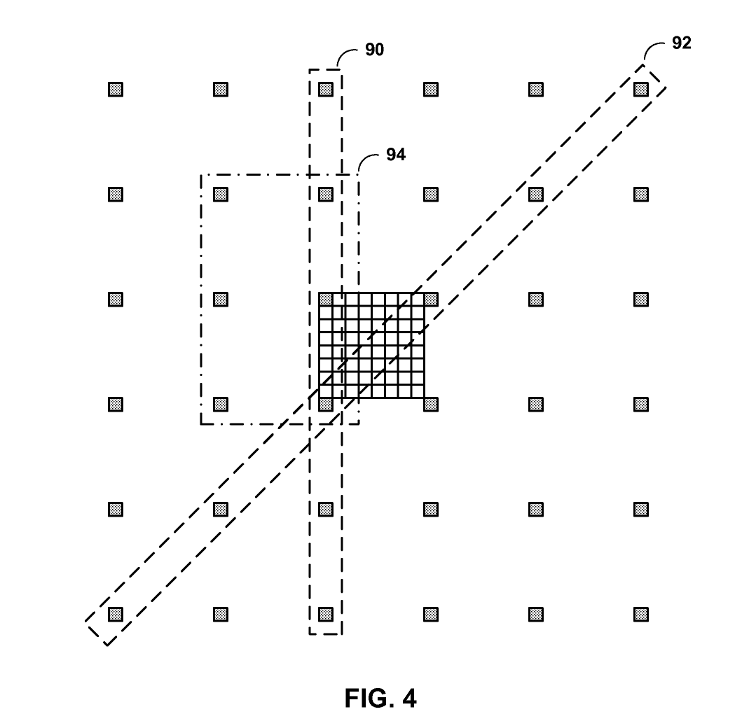

FIG. 4 is a conceptual diagram illustrating different sets of support pixels that a video coding device such as video encoder 20 or decoder 30 may use to interpolate sub-pixel values. When interpolating a sub-pixel value, a video coding device, also referred to as a video coder, such as an encoder or a decoder, may select a series of support pixels and apply an interpolation filter, such as a 6-tap Wiener filter or other finite impulse response filter (FIR) to those support pixels to interpolate a particular sub-integer pixel value or values. The set of support pixels that a video coding device uses to interpolate a particular sub-pixel may vary from one sub-pixel to another or from frame-to-frame, slice-to-slice or LCU-to-LCU. For example, a video encoder may select a series of support pixels in a straight line to interpolate one sub-pixel value, and a square pattern of sub-pixels to interpolate another sub-pixel. Even though the set of support pixels may vary, a video coding device may use the same filter on each set of support pixels. Storing only one filter may have advantages, such as reduced power consumption, device complexity, and improved device speed for the video coding device.

In FIG. 4, gray squares with solid borders represent whole pixel positions that a video coding unit, such as video encoder 20 or decoder 30 may use as support pixels to interpolate sub-pixel values. White squares with solid borders represent sub-pixel positions. For instance, the sub-pixels may be eighth-pixels, quarter-pixels, or half-pixels. Similar sub-pixel positions may exist for every integer pixel location. The pixels and sub-pixels may be part of a sub-CU, LCU, slice, or a frame. The gray squares enclosed within dashed lines or dot-dashed lines indicate example patterns of support that a video coding device may use to interpolate sub-pixel values. For instance, the pixels enclosed within rectangle 90 form a vertical column. A video coding device may apply interpolation filters to support pixels arranged this fashion to interpolate one or more of the sub-pixel values that are aligned with the support pixels contained within the vertical column. As another example, the support pixels in rectangle 92 form a diagonal line at a 45 degree angle. The video coding device might use this arrangement of support pixels to interpolate a sub-pixel located in a diagonal line with the support pixels. The sub-pixels enclosed by rectangle 94 represent yet another possible set of support pixels that a video coding device may use to interpolate a sub-pixel. As an example, a video coding unit might select the six full-pixel positions illustrated with in rectangle 94 to which to apply an interpolation filter to interpolate one or more sub-pixels of the block. A video coding device may also combine corresponding values from sets of supporting pixels having the same number of dimensions, having the same fractional resolution (for example, all one-eighth or all one-quarter sub-integer pixels) and the same number of support pixels in each set. The video coding device may then interpolate a sub-integer pixel value by applying an interpolation filter to the combined set of support sub-integer pixels.

The sets of sub-pixel support illustrated in rectangles 90, 92, and 94 of FIG. 4 are merely some examples of pixel support configurations and are not an exhaustive list of patterns of support pixels that a video coding device may use to interpolate sub-pixel values. Other examples may include “V” shaped sets of support pixels or circular or elliptical set of support pixels, as well as other differently-shaped sets of sub-pixels and different numbers of sub-pixels.

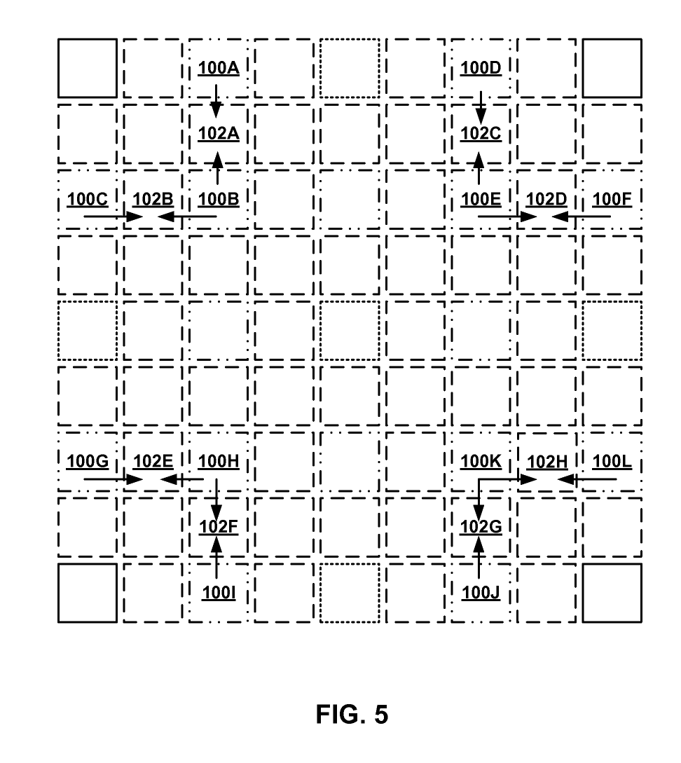

FIGS. 5-11 are conceptual diagrams illustrating examples of eighth-pixel interpolation. In these figures, each square represents a full pixel or a fractional pixel position in a video frame or slice. In FIGS. 5-11, integer pixel positions are indicated as rectangles having solid borders. Pixels located at one-half (½) pixel positions are indicated as with finely dashed borders. Quarter-pixels positions, that is, pixels located at one-fourth (¼^{th}), or three-fourths (¾^{th}) of a pixel positions, are indicated by rectangles having dot-dashed borders. Pixels located at one-eighth (⅛^{th}), three-eighths (⅜^{th}), five-eighths (⅝^{th}) and seven-eighths ( 7/8^{th}, pixel positions, are indicated as rectangles having thicker dashed borders. All squares having similar borders likewise represent pixels at the same fractional sub-pixel precision or a multiple thereof. In each of FIGS. 5-11, a video coding device, such as video encoder 20 or decoder 30 may average two or more different sub-pixels, to interpolate another eighth-pixel value. As a specific example, a video coding device, such as video encoder 20 or decoder 30, may combine the corresponding values of support pixels associated with each of the two or more sub-pixels, and apply an interpolation to the combined set of support pixels to interpolate the value of the eighth-pixel value. In FIGS. 5-11, the sub-pixels input to the averaging function are located at the tail end of the arrows, and the interpolated eighth-pixel is located at the arrowhead. The sub-pixels located at the tail end of the arrows may also represent the associated set of support pixels used to interpolate the sub-pixel located at the tail end of each arrow,

FIG. 5 illustrates techniques for eighth-pixel interpolation of a plurality of sub-pixel positions. As an example, a video coding device, also referred to as a video coder, such as video encoder 20 (FIGS. 1 and 2) or video encoder 30 (FIGS. 1 and 3) may perform the interpolation techniques illustrated in this figure. The video coding device may average values for first and second quarter-pixel positions located at the tails of two arrows to interpolate an eighth-pixel located at the converging point of the two arrowheads. As an example, a video coding unit may average values for quarter-pixels 100A and 100B to interpolate a value for eighth-pixel 102A. A video coding unit may also average values for quarter-pixels 100B and 100C to calculate a value for eighth-pixel 102B.

As another example, the video coding unit may average values for quarter-pixels 100D and 100E to interpolate a value for eighth-pixel 102C, and a value for eighth-pixel 102D as an average of values for quarter-pixels 100E and 100F. As still further examples, the video coding unit may calculate a value for eighth-pixel 102E as an average of values for quarter-pixels 100G and 100H, and a value for eighth-pixel 102F as an average of values for quarter-pixels 100H and 100I. Likewise, the video coding unit may calculate a value for eighth-pixel 102G as an average of values for quarter-pixels 100J and 100K, and a value for eighth-pixel 102G as an average of values for quarter-pixels 100K and 100L.

In this manner, the video coding device may execute formulas (1)-(8) below to calculate values for eighth-pixels 102A-102H:

$$\begin{matrix}value ( 102 A ) = \frac{value ( 100 A ) + value ( 100 B )}{2} & ( 1 ) \\ value ( 102 B ) = \frac{value ( 100 B ) + value ( 100 C )}{2} & ( 2 ) \\ value ( 102 C ) = \frac{value ( 102 D ) + value ( 102 E )}{2} & ( 3 ) \\ value ( 102 D ) = \frac{value ( 100 E ) + value ( 100 F )}{2 } & ( 4 ) \\ value ( 102 E ) = \frac{value ( 100 G ) + value ( 100 H )}{2} & ( 5 ) \\ value ( 102 F ) = \frac{value ( 100 H ) + value ( 100 I )}{2} & ( 6 ) \\ value ( 102 G ) = \frac{value ( 100 J ) + value ( 100 K )}{2} & ( 7 ) \\ value ( 102 H ) = \frac{value ( 100 K ) + value ( 100 L )}{2} & ( 8 )\end{matrix}$$

To calculate values for the first and second quarter-pixels, for example, sub-pixels 100A and 100B, the video coding device may apply a filter, such as a one-dimensional 6-tap Wiener filter to a plurality of support pixel values or sub-pixel values. To avoid a loss of pixel data precision caused by repeated rounding, the coding unit may store the values of the two quarter-pixel, such as the values of sub-pixels 100A and 100B, without rounding them. After applying the filter, the coding unit may average the two quarter-pixel values, round the two quarter-pixel values and the one eighth-pixel value to interpolate the value of the eighth-pixel, for instance eighth-pixel 102A.

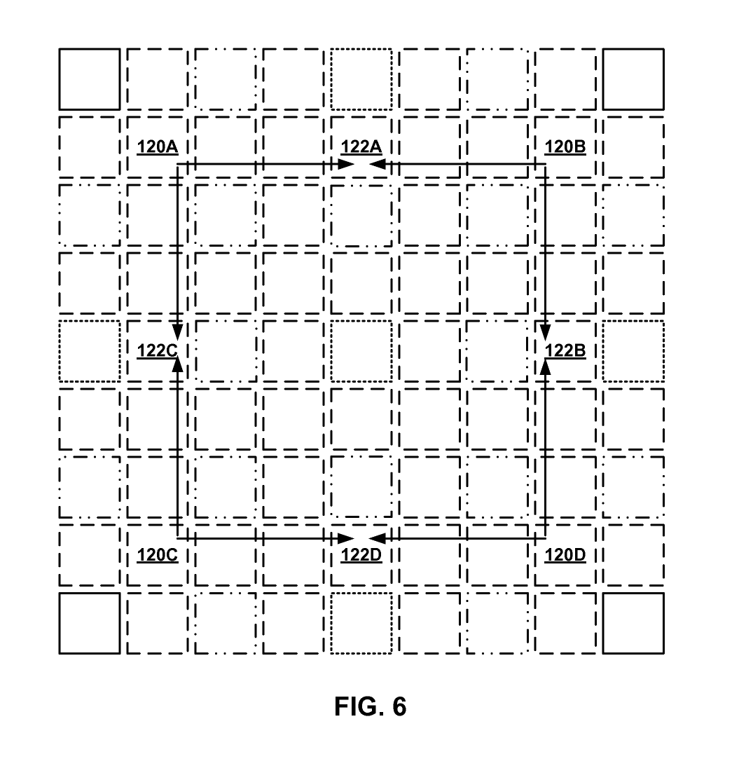

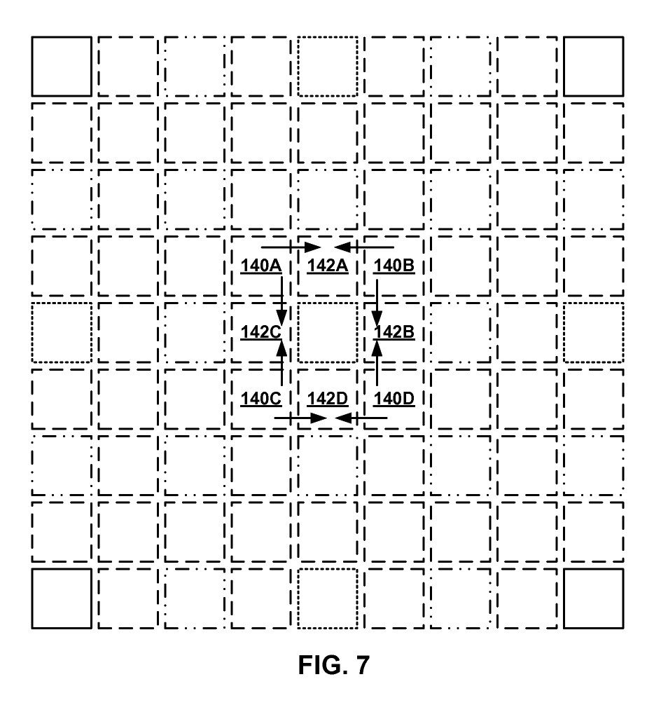

FIGS. 6-7 illustrate techniques for eighth-pixel interpolation of a plurality of sub-pixel positions. As an example, a video coding device, such as video encoder 20 or decoder 30 may perform the interpolation techniques illustrated in this figure. The video coding device may average first and second eighth-pixel values located at the tails of two arrows to interpolate an eighth-pixel located at the converging point of the two arrowheads. As an example, with respect to FIG. 6, a video coding unit may average values for eighth-pixels 120A and 120B to interpolate a value for eighth-pixel 122A, values for eighth-pixels 120B and 120D to interpolate a value for eighth-pixel 122B, values for eighth-pixels 120A and 120C to interpolate a value for eighth-pixel 122C, and values for eighth-pixels 120C and 120D to interpolate a value for eighth-pixel 122D.

In this manner, the video coding device may calculate values for eighth-pixels 122 according to formulas (9)-(12) below:

$$\begin{matrix}value ( 122 A ) = \frac{value ( 120 A ) + value ( 120 B )}{2} & ( 9 ) \\ value ( 122 B ) = \frac{value ( 120 B ) + value ( 120 D )}{2} & ( 10 ) \\ value ( 122 C ) = \frac{value ( 120 A ) + value ( 120 C )}{2} & ( 11 ) \\ value ( 122 D ) = \frac{value ( 120 C ) + value ( 120 D )}{2} & ( 12 )\end{matrix}$$

As another example, with respect to FIG. 7, the video coding device may average values for eighth-pixels 140A and 140B to interpolate a value for eighth-pixel 142A, values for eighth-pixels 140B and 140D to interpolate a value for eighth-pixel 142B, values for eighth-pixels 140A and 140C to interpolate a value for eighth-pixel 142C, and values for eighth-pixels 140C and 140D to interpolate a value for eighth-pixel 142D. In this manner, the video coding device may calculate values for eighth-pixels 142A-142D according to formulas (13)-(16) below:

$$\begin{matrix}value ( 142 A ) = \frac{value ( 140 A ) + value ( 140 B )}{2} & ( 13 ) \\ value ( 142 B ) = \frac{value ( 140 B ) + value ( 140 D )}{2} & ( 14 ) \\ value ( 142 C ) = \frac{value ( 140 A ) + value ( 140 C )}{2} & ( 15 ) \\ value ( 142 D ) = \frac{value ( 140 C ) + value ( 140 D )}{2} & ( 16 )\end{matrix}$$

To calculate the first and second eighth-pixel values, for example, sub-pixels 120A and 120B, the video coding device may apply a filter, such as a one-dimensional 6-tap Wiener filter to a plurality of support pixel values or sub-pixel values. To avoid a loss of pixel data precision caused by repeated rounding, the coding unit may store the values of the first two eighth-pixel, such as the values of sub-pixels 120A and 120B, without rounding them. After applying the filter, the coding unit may average the first two eighth-pixel values to produce a third eighth-pixel value, round the first two eighth-pixel values and the third eighth-pixel value to interpolate the value of the eighth-pixel, for instance 122A.

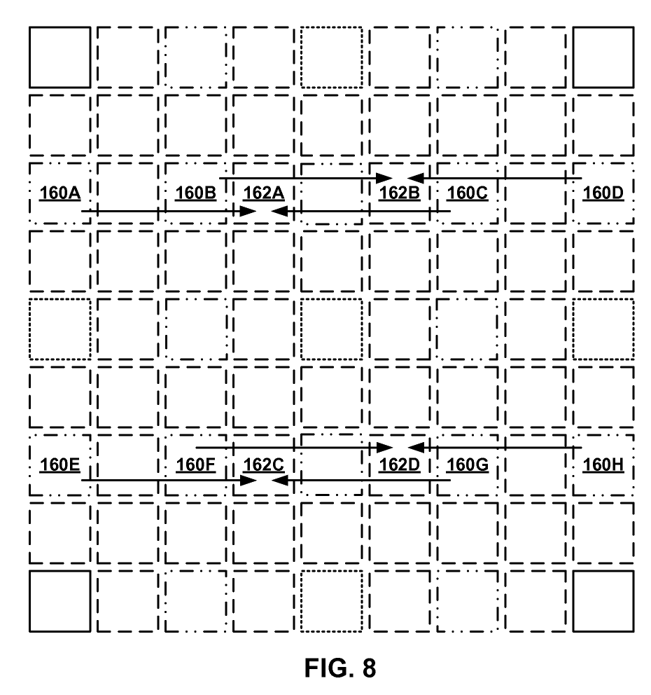

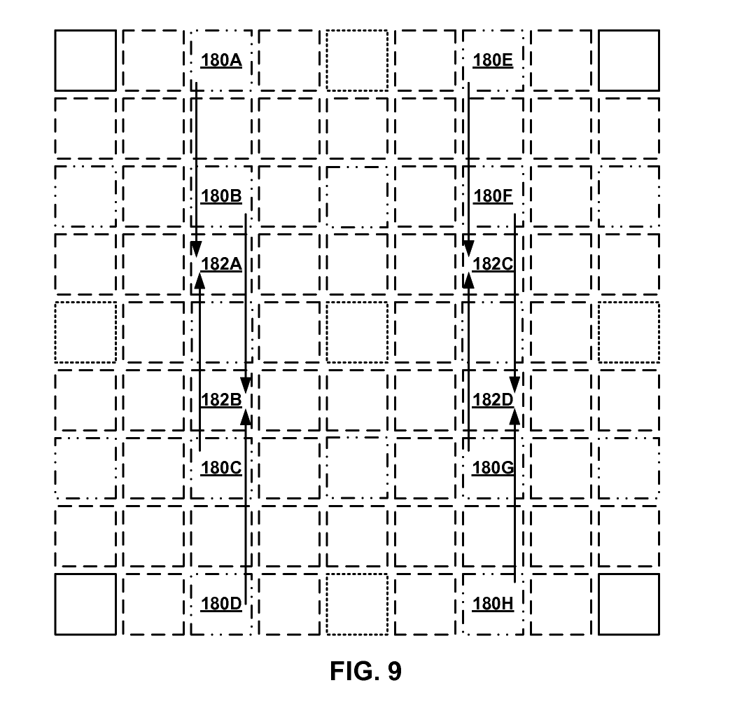

FIGS. 8-9 also illustrate techniques for eighth-pixel interpolation of a plurality of sub-pixel positions. As an example, a video coding device, such as video encoder 20 or decoder 30 may perform the interpolation techniques illustrated in these figures. The video coding device may average first and second quarter-pixel values located at the tails of two arrows to interpolate an eighth-pixel located at the converging point of the two arrowheads. As examples with respect to FIG. 8, a video coding device may average values for quarter-pixels 160A and 160C to interpolate a value for eighth-pixel 162A, values for quarter-pixels 160B and 160D to interpolate a value for eighth-pixel 162B, values for quarter-pixels 160E and 160G to interpolate a value for eighth-pixel 162C, and values for quarter-pixels 160F and 160H to interpolate a value for eighth-pixel 162D.

In this manner, the video coding device may calculate values for eighth-pixels 162A-162D according to formulas (17)-(20) below:

$$\begin{matrix}value ( 162 A ) = \frac{value ( 160 A ) + value ( 160 C )}{2} & ( 17 ) \\ value ( 162 B ) = \frac{value ( 160 B ) + value ( 160 D )}{2} & ( 18 ) \\ value ( 162 C ) = \frac{value ( 160 E ) + value ( 160 G )}{2} & ( 19 ) \\ value ( 162 D ) = \frac{value ( 160 F ) + value ( 160 H )}{2} & ( 20 )\end{matrix}$$

As another example with respect to FIG. 9, the video coding unit may average values for quarter-pixels 180A and 180C to interpolate a value for eighth-pixel 182A, values for quarter-pixels 180B and 180D to interpolate a value for eighth-pixel 182B, values for quarter-pixels 180E and 180G to interpolate a value for eighth-pixel 182C, and values for quarter-pixels 180F and 180H to interpolate a value for eighth-pixel 182D. In this manner, the video coding device may calculate values for eighth-pixels 182A-182D according to formulas (21)-(24) below:

$$\begin{matrix}value ( 182 A ) = \frac{value ( 180 A ) + value ( 180 C )}{2} & ( 21 ) \\ value ( 182 B ) = \frac{value ( 180 B ) + value ( 180 D )}{2} & ( 22 ) \\ value ( 182 C ) = \frac{value ( 180 E ) + value ( 180 G )}{2} & ( 23 ) \\ value ( 182 D ) = \frac{value ( 180 F ) + value ( 180 H )}{2} & ( 24 )\end{matrix}$$

To calculate the first and second quarter-pixel values, for example, sub-pixels 180A and 180B, the video coding device may apply a filter, such as a one-dimensional 6-tap Wiener filter to a plurality of support pixel values or sub-pixel values. To avoid a loss of pixel data precision caused by repeated rounding, the coding unit may store the values of the two quarter-pixel, such as the values of sub-pixels 180A and 180B, without rounding them. After applying the filter, the coding unit may average the two quarter-pixel values to produce an eighth-pixel value, and round the two quarter-pixel values and the eighth-pixel value to interpolate the value of the eighth-pixel, for instance 180C.

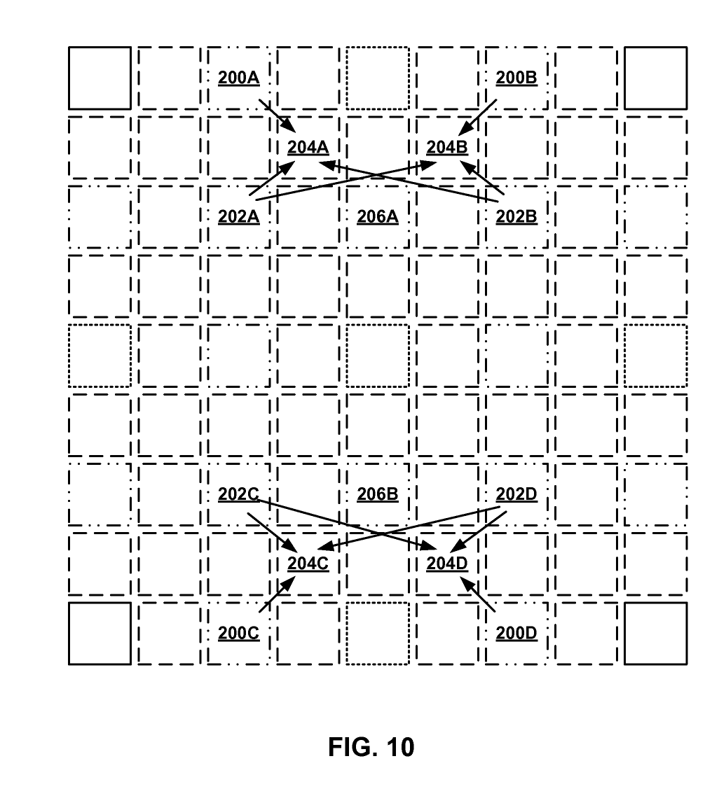

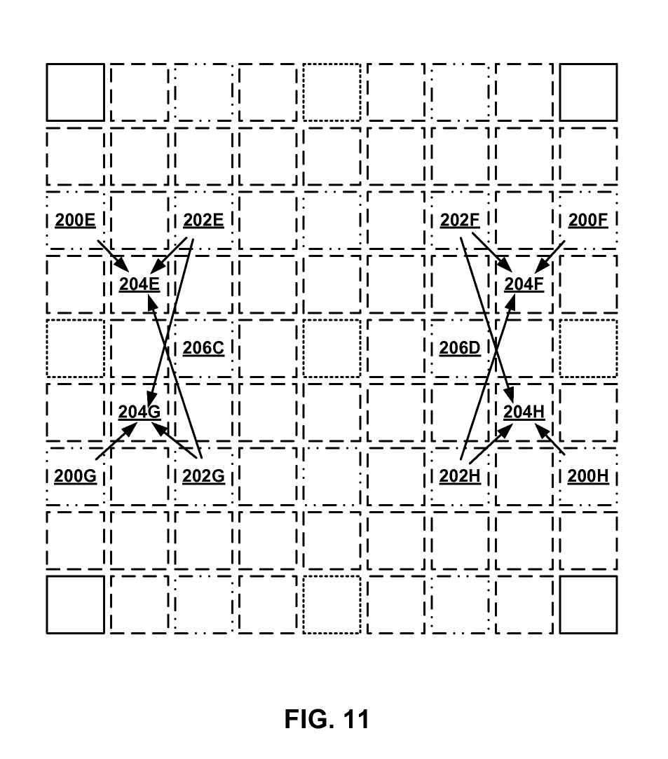

FIGS. 10-11 illustrate additional examples of techniques for eighth-pixel interpolation for a plurality of sub-pixel positions. For example, a coding device may calculate a value for eighth-pixel position 204A as an average of values for quarter-pixels 200A and 206A. The coding device may calculate a value of quarter-pixel position 206A as an average of values for quarter-pixels 202A and 202B. In this manner, the coding device may calculate the value for eighth-pixel 204A as an average of twice the value for quarter-pixel 200A and the values for quarter-pixels 202A and 202B. In some examples, the value for quarter-pixel 206A may not actually correspond to an average of the values of quarter pixels 202A and 202B, but the average of the values of quarter pixels 202A and 202B may nevertheless be used to calculate the value of eighth-pixel 204A. In another example, the video coding device may combine the sets of support pixels used to interpolate the values of quarter pixels 200A and 206B, apply an interpolation filter to the combined sets of support, and, if necessary, divide the final result by a constant. The video coding device may also combine the corresponding values from the support pixels of 200A, 202A, and 202B, and apply an interpolation filter to the combined set of support pixels to calculate the value of eighth-pixel 204A.

For example, the coding device may calculate the value of eighth-pixel 204A according to formula (25) below:

$$value ( 204 A ) = \frac{value ( 200 A ) + value ( 206 A )}{2 } \qquad ( 25 )$$

Meanwhile, the coding device may calculate the value of quarter-pixel 206A (or a value corresponding to this position for the purpose of calculating the value of eighth-pixel 204A) according to formula (26) below:

$$value ( 206 A ) = \frac{value ( 202 A ) + value ( 202 B )}{2} \qquad ( 26 )$$

Thus, combining formulas (x) and (x+1) yields formula (x+2), as shown below, which the coding device may use to calculate the value of eighth-pixel 204A:

$$value ( 204 A ) = \frac{value ( 200 A ) + \frac{value ( 202 A ) + value ( 202 B )}{2}}{2} \\ value ( 204 A ) = \frac{value ( 200 A )}{2} + \frac{value ( 202 A ) + value ( 202 B )}{4} \\ value ( 204 A ) = \frac{2 * value ( 200 A ) + value ( 202 A ) + value ( 202 B )}{4} \qquad ( 27 )$$

In addition to the methods described in equations 25-41, the value portions of each equation, e.g. “value (200A),” may each be substituted with the support pixel values corresponding to each sub-pixel position in the “value” expression, and each corresponding sub-integer support pixel for each sub-pixel in the parentheses of the value position may be combined, and then an interpolation filter applied to the combined set of support. The coding device may then take the quotient of the result of the interpolation filter, with the divisor being the denominator in each expression. In the example of equation 27, twice the value of the support pixels associated with sub-integer pixel 200A may be combined with the corresponding support pixels associated with sub-pixel position 202A, and the support pixels associated with sub-integer pixel position 202B. The coding device may apply an interpolation filter to the combined set of support and take the result of the interpolation filter divided by four to determine the value of one-eighth-pixel position 204A.

Similarly, the coding device may calculate the value for eighth-pixel 204B as an average of twice the value for quarter-pixel 200B and the values for quarter-pixels 202A and 202B. Thus, the value of eighth-pixel 204B may approximate an average of the values of quarter-pixels 200B and 206A, assuming that quarter-pixel 206A has a value that approximates an average of quarter-pixels 202A and 202B. In another example, the coding device may combine the sets of support pixels used to interpolate the values of quarter pixels 200B and 206A, apply an interpolation filter to the combined sets of support, and, if necessary, divide the final result by a constant. The video coding device may also combine the corresponding values from the support pixels of 200B, 202A, and 202B, and apply an interpolation filter to the combined set of support pixels to calculate the value of eighth-pixel 204A. Accordingly, to calculate the value of eighth-pixel 204B, the video coding device may execute one of formulas (28) or (29):

$$\begin{matrix}value ( 204 B ) = \frac{value ( 200 B ) + value ( 206 A )}{2} & ( 28 ) \\ value ( 204 B ) = \frac{2 * value ( 200 B ) + value ( 202 A ) + value ( 202 B )}{4} & ( 29 )\end{matrix}$$

In a similar manner, the video coding device may calculate values for eighth-pixel 204C from averages of values for quarter-pixels 200C and 206B, and eighth-pixel 204D from averages of values for quarter-pixels 200D and 206B, where the value of quarter-pixel 206B may correspond to an average of values for quarter-pixels 202C and 202D. Thus, the video coding device may calculate values for eighth-pixels 204C and 204D using respective ones of formulas (30)-(33):

$$\begin{matrix}value ( 204 C ) = \frac{value ( 200 C ) + value ( 206 B )}{2} & ( 30 ) \\ value ( 204 C ) = \frac{2 * value ( 200 C ) + value ( 202 C ) + value ( 202 D )}{4} & ( 31 ) \\ value ( 204 D ) = \frac{value ( 200 D ) + value ( 206 B )}{2 } & ( 32 ) \\ value ( 204 D ) = \frac{2 * value ( 200 D ) + value ( 202 C ) + value ( 202 D )}{4} & ( 33 )\end{matrix}$$

Likewise, the video coding device may calculate values for eighth-pixel 204E from averages of values for quarter-pixels 200E and 206C, and eighth-pixel 204G from averages of values for quarter-pixels 200G and 206C, where the value of quarter-pixel 206C may correspond to an average of values for quarter-pixels 202E and 202G. Thus, the video coding device may calculate values for eighth-pixels 204E and 204G using respective ones of formulas (34)-(37):

$$\begin{matrix}value ( 204 E ) = \frac{value ( 200 E ) + value ( 206 C )}{2} & ( 34 ) \\ value ( 204 E ) = \frac{2 * value ( 200 E ) + value ( 202 E ) + value ( 202 G )}{4} & ( 35 ) \\ value ( 204 G ) = \frac{value ( 200 G ) + value ( 206 C )}{2} & ( 36 ) \\ value ( 204 G ) = \frac{2 * value ( 200 G ) + value ( 202 E ) + value ( 202 G )}{4} & ( 37 )\end{matrix}$$

Similarly, the video coding device may calculate values for eighth-pixel 204F from averages of values for quarter-pixels 200F and 206D, and eighth-pixel 204H from averages of values for quarter-pixels 200H and 206D, where the value of quarter-pixel 206D may correspond to an average of values for quarter-pixels 202F and 202H. Thus, the video coding device may calculate values for eighth-pixels 204F and 204H using respective ones of formulas (38)-(41):

$$\begin{matrix}value ( 204 F ) = \frac{value ( 200 F ) + value ( 206 D )}{2} & ( 38 ) \\ value ( 204 F ) = \frac{2 * value ( 200 F ) + value ( 202 F ) + value ( 202 H )}{4} & ( 39 ) \\ value ( 204 H ) = \frac{value ( 200 H ) + value ( 206 D )}{2} & ( 40 ) \\ value ( 204 H ) = \frac{2 * value ( 200 H ) + value ( 202 F ) + value ( 202 H )}{4} & ( 41 )\end{matrix}$$

A coding device such as video encoder 20 or video encoder 30 (FIG. 1) may perform the interpolation techniques illustrated in these figures. In the techniques illustrated in FIGS. 10-11, the video coding device may interpolate an eighth-pixel value by averaging first, second, and third quarter-pixel values to interpolate a one-eighth pixel value. The video coding device may calculate the value for the eighth-pixel position as the sum of two times a first quarter-pixel value, added with a third and fourth quarter-pixel. The coding device may interpolate an eighth-pixel value by determining first, second, and third sets of support pixels for each of the quarter-pixel positions. The coding device may then combine the corresponding pixels from each set of support pixels, apply an interpolation filter to the combined set of support, and divide the result of the interpolation filter by a constant. The first quarter-pixel may be positioned at a positive or negative forty-five degree angle relative to the eighth-pixel.

In FIGS. 10 and 11, the first quarter-pixel may correspond to one of one-quarter pixels 200A-200H. Each of the quarter-pixel values is located at the tail of an arrow, the head of each which points to an eighth-pixel for which a value is calculated using the quarter-pixel values or the supporting pixel values of each quarter-pixel. To calculate values of the first, second, and third quarter-pixel values, the coding device may apply a filter, such as a one-dimensional 6-tap Wiener filter to a plurality of support pixels or sub-pixels. To avoid a loss of pixel data precision caused by repeated rounding, the video coding device may store the values of the three quarter-pixel values without rounding them.

After applying the filter to determine each quarter-pixel value, the coding device may average the quarter-pixel values, round the eighth-pixel value, and the quarter-pixel values. As an example, the video coding device may calculate the values of quarter-pixels 200E, 202E, and 202G and store the values without rounding them. The video coding device may calculate the average of twice the value of quarter-pixel 200E, added with the values of quarter-pixels 202E and 202G. The video coding unit may round the values of quarter-pixels 200E, 202E, and 202G in order to calculate the final pixel values of those quarter-pixels. The video coding unit may also round the average of the three quarter pixels and store that as the value of eighth-pixel 204E.

Rather than averaging the values of quarter-pixels, the coding device may combine the corresponding sets of support pixel values for each quarter-pixel position. The coding device may further apply an interpolation filter to the combined set of support pixels and, if necessary, divide the resulting value by a constant, to calculate the value of the eighth-pixel. As an example, a coding device may combine twice the values of the support pixels for quarter-pixel 200E with the support pixel values for quarter-pixels 202E and 202G. The coding device may further apply an interpolation filter to the combined support pixel values and divide the result of the filter by four to determine the final value for eighth-pixel 204E.

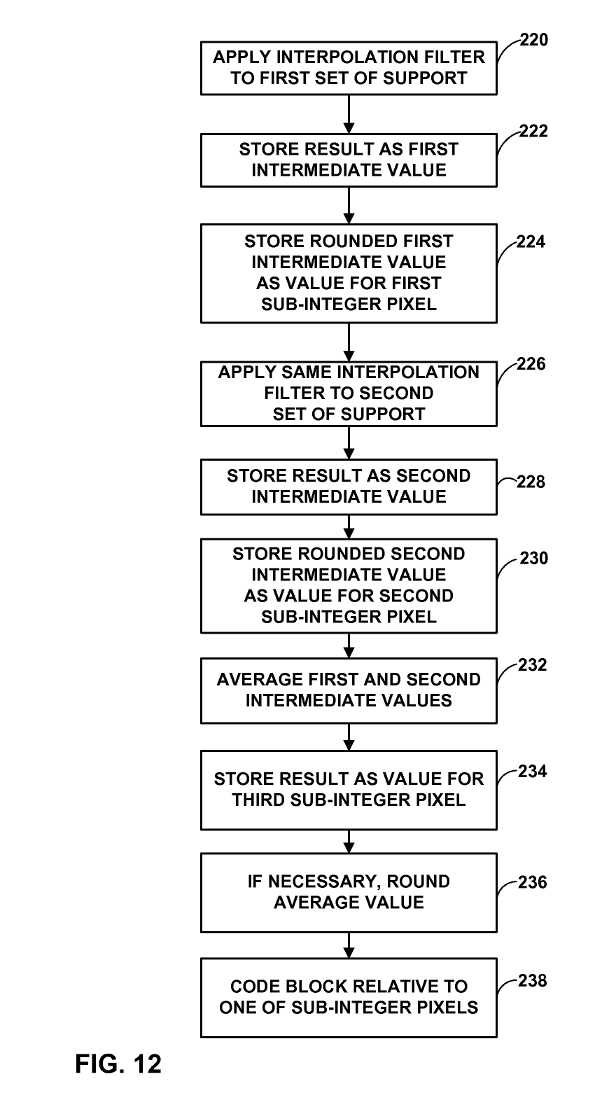

FIG. 12 is a flowchart illustrating an example method for interpolating an eighth-pixel value. The techniques of FIG. 12 may generally be performed by any processing unit or processor, whether implemented in hardware, software, firmware, or a combination thereof, and when implemented in software or firmware, corresponding hardware may be provided to execute instructions for the software or firmware. For purposes of example, the techniques of FIG. 12 are described with respect to a video coding device, which may include components substantially similar to those of video encoder 20 (FIGS. 1 and 2) and/or video decoder 30 (FIGS. 1 and 3), although it should be understood that other devices may be configured to perform similar techniques. Moreover, the steps illustrated in FIG. 12 may be performed in a different order or in parallel, and additional steps may be added and certain steps omitted, without departing from the techniques of this disclosure.

In the method illustrated in FIG. 12, a video coding device such as video encoder 20 and/or video decoder 30 may apply an interpolation filter to a first set of support (220), store the result as a first intermediate value (222), and store the rounded first intermediate value as the value for a first sub-integer pixel (224). For example, the video coding device may apply an interpolation filter to a set of support pixels to calculate the values of quarter-pixels 100A-100B, 102A-102B, 104A-104B, and 106A-106C, in FIG. 5 or eighth-pixels 120A-120D in FIG. 6. The video coding device may apply the same interpolation filter to a second, different set of support (226), store the result as a second intermediate value (228), and store the rounded second intermediate value as the value for the second sub-integer pixel (230). Though illustrated sequentially, steps 220-234 may be performed in parallel.

The video coding device may average the first and second intermediate values (232), store the result as the value for a third sub-integer pixel, and if necessary, round the average value (236) from 232. A video coding device may perform rounding to comply with an allocated number of bits. As examples of this sub-pixel interpolation technique, the video coding device may calculate values for sub-integer pixels, such as sub-integer pixels 102, 122, 142, 162, and/or 182 of FIGS. 5-9, in this manner. The video coding device may also code a block relative to one of the integer sub-pixels (238). For example, the video coding device may calculate a motion vector that indicates the location of one of eighth-pixels 122, 142, 162, and/or 182 for the current block as part of an encoding process and encode the current block relative to a reference block including the one of the eighth-pixels. As another example, the video coding device may receive a motion vector that indicates the location of one of eighth-pixels 122, 142, 162, and/or 182 and decode the current block relative to a reference block including the one of the eighth-pixels.

In this manner, the method of FIG. 12 represents an example of a video coding method including applying an interpolation filter to a first set of supporting pixels, applying the interpolation filter to a second, different set of supporting pixels, calculating a value for a one-eighth pixel position of a pixel of a reference block of video data as an average of the first and second intermediate values resulting from application of the interpolation filter to the first set of supporting pixels and the second set of supporting pixels, and coding a portion of a current block of the video data relative to the one-eighth pixel position of the reference block.

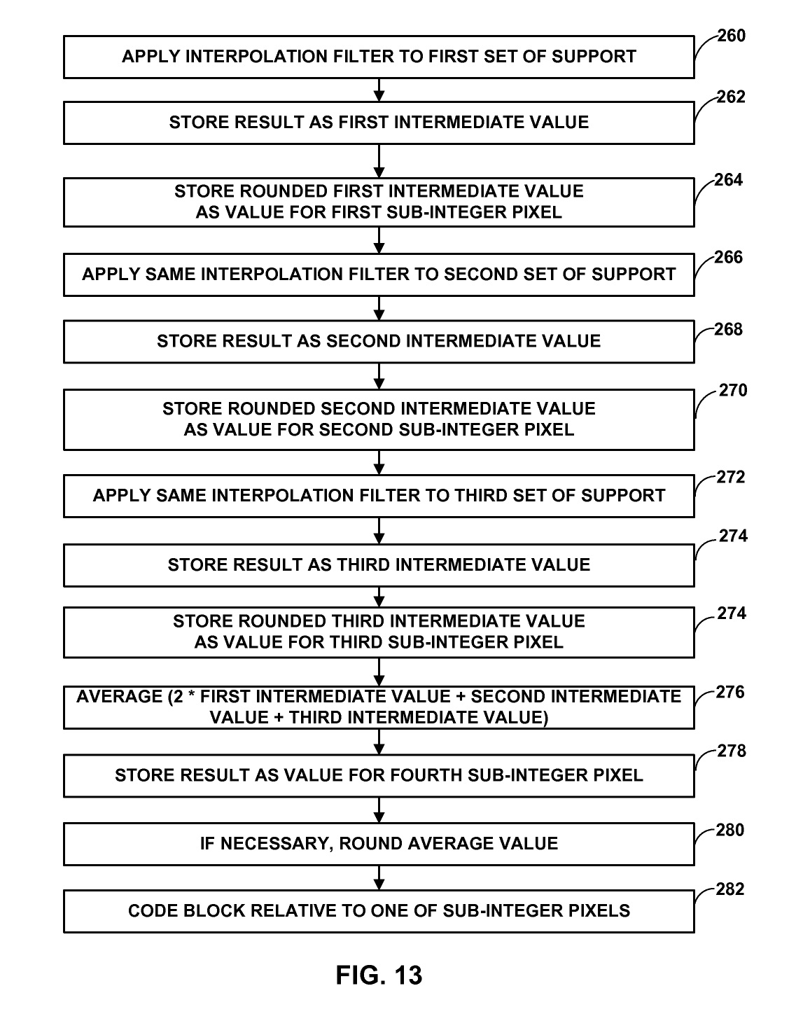

FIG. 13 is a flowchart illustrating an example method for one-eighth sub-pixel interpolation. The techniques of FIG. 13 may generally be performed by any processing unit or processor, whether implemented in hardware, software, firmware, or a combination thereof, and when implemented in software or firmware, corresponding hardware may be provided to execute instructions for the software or firmware. For purposes of example, the techniques of FIG. 13 are described with respect to a video coding device such as video encoder 20 (FIGS. 1 and 2) and/or video decoder 30 (FIGS. 1 and 3), although it should be understood that other devices may be configured to perform similar techniques. Moreover, the steps illustrated in FIG. 13 may be performed in a different order or in parallel, and additional steps may be added and certain steps omitted, without departing from the techniques of this disclosure.

In the method illustrated in FIG. 13, a video coding device may apply an interpolation filter to a first set of support (260), store the result as a first intermediate value (262), and store the rounded first intermediate value as the value for a first sub-integer pixel (264). The video coding device may similarly apply the same interpolation filter to a second set of support, store the result as a second intermediate value (268), and store the second rounded intermediate value as the value for the second sub-integer pixel value. Though illustrated sequentially, steps 260-274 may be performed in parallel.

The video coding device may also similarly apply an interpolation filter to a third, different set of support (272), store the result as a third intermediate value, and store the rounded result as the value for a third sub-integer pixel (274). Although steps 260-274 appear sequentially, a video coding device may perform them in parallel. The video coding device may average two times the first intermediate value, added with the second, and third intermediate values (276), and store the result as the value for a fourth sub-integer pixel (278). For example, the video coding device may calculate values for sub-integer pixels, such as sub-integer pixels 204A-204H of FIGS. 10-11.

The first quarter-pixel may form one of a positive forty-five degree angle, or negative forty-five degree angle with the fourth eighth-pixel. For example, quarter-pixels 200A-200H may comprise first quarter-pixels. If necessary, the video coding device may round the average value calculated in step 278. The video coding device may perform rounding to comply with an allocated number of bits.

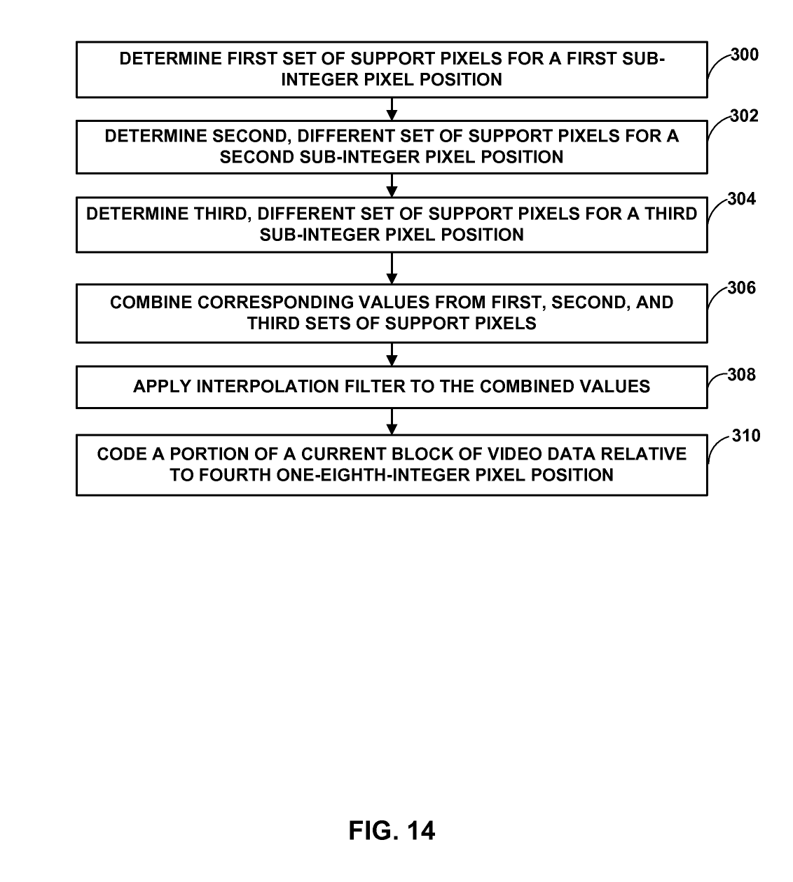

FIG. 14 is a flowchart illustrating an example method for one-eighth sub-pixel interpolation. The techniques of FIG. 14 may generally be performed by any processing unit or processor, whether implemented in hardware, software, firmware, or a combination thereof, and when implemented in software or firmware, corresponding hardware may be provided to execute instructions for the software or firmware. For purposes of example, the techniques of FIG. 14 are described with respect to a video coding device such as video encoder 20 (FIGS. 1 and 2) and/or video decoder 30 (FIGS. 1 and 3), although it should be understood that other devices may be configured to perform similar techniques. Moreover, the steps illustrated in FIG. 14 may be performed in a different order or in parallel, and additional steps may be added and certain steps omitted, without departing from the techniques of this disclosure.

In the method illustrated in FIG. 14, a video coding device may determine a first set of support pixels for a first sub-integer pixel position of a pixel of a reference block of video data (300), select a second, different set of support pixels for a second sub-integer pixel position of the pixel (302), and determine a third, different set of support pixels for a third sub-integer pixel position of the pixel (304). The video coding device may combine the corresponding values from the first, second, and third sets of support pixels (306). The video coding device may further apply an interpolation filter to the combined values to calculate a value for a fourth one-eighth-pixel position of the pixel (308), and code a portion of a current block of the video data relative to the fourth one-eighth-integer position of the reference block (310). Though illustrated sequentially, steps 300-310 may be performed in parallel.

For example, the video coding device may calculate values for sub-integer pixels, such as sub-integer pixels 204A-204H of FIGS. 10-11. To calculate the value of one-eighth-pixel 204G, the coding device may first determine the support pixels for sub-integer pixels 200G, 202G, and 206C. The video coding device may combine the twice the values of the support pixels for sub-integer pixel 200G with the support pixels for sub-integer pixel 202G and 206C. The video coding device may then apply an interpolation filter to the combined set of support pixels, and code a portion for a current block of video data relative to one-eighth-pixel value 204G. The first quarter-pixel may form one of a positive forty-five degree angle, or negative forty-five degree angle with the fourth eighth-pixel. For example, quarter-pixels 200A-200H may comprise first quarter-pixels.

The video coding device may also code a block relative to one of the integer sub-pixels (e.g., as described with respect to step 238 of FIG. 12). For example, an encoder, such as video encoder 20, may use the coded eighth-pixel value calculated using the techniques of FIG. 12 or 13 to perform motion estimation utilizing motion estimation unit 42 or another device. During motion estimation, the motion estimation unit may compare one or more reference frames from a reference frame store to a block to be encoded of a current frame. The motion estimation unit may calculate a motion vector referring to a sub-pixel location in the reference frame store. Motion estimation unit may send the calculated motion vector to entropy coding unit 56 and motion compensation unit 44.

Motion estimation unit 42 compares blocks of one or more reference frames from reference frame store 64 to a block to be encoded of a current frame, for example, a P-frame or a B-frame. When the reference frames in reference frame store 64 include values for sub-integer pixels, a motion vector calculated by motion estimation unit 42 may refer to a sub-integer pixel location of a reference frame. Motion estimation unit 42 and/or motion compensation unit 44 may also be configured to calculate values for sub-integer pixel positions of reference frames stored in reference frame store 64 if no values for sub-integer pixel positions are stored in reference frame store 64. Motion estimation unit 42 sends the calculated motion vector to entropy coding unit 56 and motion compensation unit 44. The reference frame block identified by a motion vector may be referred to as a predictive block. Likewise, motion compensation unit 72 of video decoder 30 (FIG. 3) may conform substantially to motion compensation unit 44, albeit receiving a motion vector from entropy decoding unit 70 rather than from a motion estimation unit.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, for example, according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (for example, a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
determining a first set of support pixels used to interpolate a value for a first sub-integer pixel position of a pixel of a reference block of video data;
determining a second, different set of support pixels used to interpolate a value for a second sub-integer pixel position of the pixel;
determining a third, different set of support pixels used to interpolate a value for a third sub-integer pixel position of the pixel;
combining corresponding values from the first, second, and third sets of support pixels;
applying an interpolation filter to the combined values to calculate a value for a fourth sub-integer pixel comprising a one-eighth-integer position of the pixel; and
coding a portion of a current block of the video data relative to the fourth one-eighth-integer pixel position of the reference block.

2. The method of claim 1, wherein the interpolation filter comprises a one-dimensional interpolation filter.

3. The method of claim 1, wherein the calculated value for the fourth one-eighth-pixel position of the pixel approximates an average of twice a value for the first sub-integer pixel position, a value for the second sub-integer pixel position, and a value for the third sub-integer pixel position.

4. The method of claim 1, wherein coding the portion of the current block comprises encoding the current block relative to the fourth one-eighth pixel position of the pixel of the reference block, and wherein encoding the portion of the current block comprises calculating a residual value for the current block as a difference between the reference block and the current block.

5. The method of claim 1, wherein coding the portion of the current block comprises decoding the current block relative to the fourth one-eighth pixel position of the pixel of the reference block, and wherein decoding the portion of the current block comprises calculating a reconstructed value for the current block as a sum of the reference block and a received residual value for the current block.

6. An apparatus for coding video data, the apparatus comprising a video coder configured to determine a first set of support pixels used to interpolate a value for a first sub-integer pixel position of a pixel of a reference block of video data, determine a second, different set of support pixels used to interpolate a value for a second sub-integer pixel position of the pixel, determine a third, different set of support pixels used to interpolate a value for a third sub-integer pixel position of the pixel, combine corresponding values from the first, second, and third sets of support pixels, apply an interpolation filter to the combined values to calculate a value for a fourth sub-integer-pixel comprising a one-eighth-integer position of the pixel and code a portion of a current block of the video data relative to the fourth one-eighth-integer pixel position of the reference block.

7. The apparatus of claim 6, wherein the apparatus comprises at least one of:
an integrated circuit;
a microprocessor; and
a wireless communication device that includes the video coder.

8. The apparatus of claim 6, wherein the interpolation filter comprises a one-dimensional interpolation filter.

9. The apparatus of claim 6, wherein the calculated value for the fourth one-eighth-pixel position of the pixel approximates an average of twice a value for the first sub-integer pixel position, a value for the second sub-integer pixel position, and a value for the third sub-integer pixel position.

10. The apparatus of claim 6, wherein the video coder comprises a video encoder, and wherein to code the portion of the current block of the video data relative to the fourth one-eighth pixel position of the pixel of the reference block, the video encoder is configured to calculate a residual value for the current block as a difference between the reference block and the current block while encoding the current block.

11. The apparatus of claim 6, wherein the video coder comprises a video decoder, and wherein to code the portion of the current block of the video data relative to the fourth one-eighth pixel position of the pixel of the reference block, the video decoder is configured to calculate a reconstructed value for the current block as a sum of the reference block and a received residual value for the current block while decoding the current block.

12. An apparatus for coding video data, the apparatus comprising:
means for determining a first set of support pixels used to interpolate a value for a first sub-integer pixel position of a pixel of a reference block of video data;
means for determining a second, different set of support pixels used to interpolate a value for a second sub-integer pixel position of the pixel;
means for determining a third, different set of support pixels used to interpolate a value for a third sub-integer pixel position of the pixel;
means for combining corresponding values from the first, second, and third sets of support pixels;
means for applying an interpolation filter to the combined values to calculate a value for a fourth sub-integer pixel comprising a one-eighth-integer position of the pixel; and
means for coding a portion of a current block of the video data relative to the fourth one-eighth-integer pixel position of the reference block.

13. The apparatus of claim 12, wherein the interpolation filter comprises a one-dimensional interpolation filter.

14. The apparatus of claim 12, wherein the calculated value for the fourth one-eighth-pixel position of the pixel approximates an average of twice a value for the first sub-integer pixel position, a value for the second sub-integer position, and a value for the third sub-integer pixel position.

15. The apparatus of claim 12, wherein the means for coding the portion of the current block of the video data relative to the fourth one-eighth pixel position of the pixel of the reference block comprises means for encoding the portion of the current block, comprising means for calculating a residual value for the current block as a difference between the reference block and the current block while encoding the current block.

16. The apparatus of claim 12, wherein the means for coding the portion of the current block of the video data relative to the fourth one-eighth pixel position of the pixel of the reference block comprises means for decoding the portion of the current block, comprising means for calculating a reconstructed value for the current block as a sum of the reference block and a received residual value for the current block while decoding the current block.

17. A computer program product comprising a computer-readable storage medium having stored thereon instructions that, when executed, cause a processor of a device for coding video data to:
determine a first set of support pixels used to interpolate a value for a first sub-integer pixel position of a pixel of a reference block of video data;
determine a second, different set of support pixels used to interpolate a value for a second sub-integer pixel position of the pixel;
determine a third, different set of support pixels used to interpolate a value for a third sub-integer pixel position of the pixel;
combine corresponding values from the first, second, and third sets of support pixels;
apply an interpolation filter to the combined values to calculate a value for a fourth sub-integer pixel comprising a one-eighth-integer position of the pixel; and
code a portion of a current block of the video data relative to the fourth one-eighth-integer pixel position of the reference block.

18. The computer program product of claim 17, wherein the interpolation filter comprises a one-dimensional interpolation filter.

19. The computer program product of claim 17, wherein the calculated value for the fourth one-eighth-pixel position of the pixel approximates an average of twice a value for the first sub-integer pixel position, a value for the second sub-integer pixel position, and a value for the third one-eighth-pixel position.

20. The computer program product of claim 17, wherein the instructions that cause the processor to code the portion of the current block comprise instructions that cause the processor to encode the portion of the current block relative to the fourth one-eighth pixel position of the pixel of the reference block, comprising instructions that cause the processor to calculate a residual value for the current block as a difference between the reference block and the current block while encoding the current block.

21. The computer program product of claim 17, wherein the instructions that cause the processor to code the portion of the current block comprise instructions that cause the processor to decode the portion of the current block relative to the fourth one-eighth pixel position of the pixel of the reference block, comprising instructions that cause the processor to calculate a reconstructed value for the current block as a sum of the reference block and a received residual value for the current block while decoding the current block.
